(19) United States
(12) Patent Application Publication
(10) Pub. No.: US 2024/0219018 A1
(43) Pub. Date: Jul. 4, 2024

(54) Modular Lighting Apparatus with Cooling Channel

(71) Applicant: Schreder S.A., Brussels (BE)

(72) Inventor: Uwe Klammeck, Liege (BE)

(21) Appl. No.: 18/558,322

(22) PCT Filed: May 9, 2022
(86) PCT No.: PCT/EP2022/062509

§ 371 Date: Oct. 31, 2023

(30) Foreign Application Priority Data
May 7, 2021 (NL) 2028173

(51) Int. Cl. F21V 29/83; F21S 2/00; F21V 15/01; F21V 23/00; F21Y 103/10

(52) U.S. Cl. CPC F21V 29/83; F21S 2/005; F21V 15/01; F21V 23/008; F21Y 2103/10

(57) ABSTRACT

A lighting apparatus comprising: a plurality of housings comprising a first housing having a first wall and a second housing having a second wall; wherein said first wall faces said second wall; at least one lighting unit being provided to the first housing; a spacing means configured for arranging said first wall at a distance of said second wall such that an air flow channel is defined between the first wall and the second wall, a minimum distance between the first wall and the second wall being at most 3 cm, preferably at most 1 cm, more preferably at most 5 mm, and being larger than 0.5 mm, preferably larger than 1 mm, said air flow channel extending in an upward direction between an air entrance and an air exit; wherein said first and second walls are made of a thermally conductive material.

### FIELD OF INVENTION

The field of the invention relates to lighting apparatuses, preferably for outdoor lighting or industrial lighting. Particular embodiments relate to a lighting apparatus comprising modules and forming a cooling channel.

### BACKGROUND

Despite the progress of technology towards more electricity-efficient lighting solutions, heat is still being generated by power-intensive components of lighting apparatuses. As such, heat management in lighting apparatuses is still a major design point to tackle in order to prevent onboard electronics from overheating, which would in turn cause malfunctions in the lighting apparatuses. Typically, lighting apparatuses are air cooled using air convection. In order to promote heat exchange between the heat generated by the electronics and the surrounding cooler air, heat sinks can be used which try to increase the surface in contact with the coolant to promote heat exchange. Alternatively or additionally, air channels can be used which try to promote air circulation. However, design requirements for these types of solutions are usually quite demanding in terms of space and/or in terms of complexity.

In particular, the design of heat sinks generally foregoes aesthetical considerations, and heat sinks are prone to dirt accumulation within their recesses over time, thereby decreasing their efficiency. On the other hand, the design of air channels generally introduces complex shapes within the housing of the lighting apparatus, thereby increasing production costs. Thus, there is a need for an alternative cooling solutions taking into account the typical problems encountered.

### SUMMARY

The object of embodiments of the invention is to provide a lighting apparatus allowing for air cooling of the components contained within the lighting apparatus which keeps its effectivity over time and which presents a simpler design compared to the existing ones.

According to a first aspect of the invention, there is provided a lighting apparatus. The lighting apparatus comprises: a plurality of housings, at least one lighting unit, and a spacing means. The plurality of housings comprises a first housing having a first wall and a second housing having a second wall. The first wall faces said second wall. The at least one lighting unit is provided to the first housing, preferably in the first housing. The spacing means is configured for arranging said first wall at a distance of said second wall such that an air flow channel is defined between the first wall and the second wall, a minimum distance between the first wall and the second wall being at most 3 cm, preferably at most 1 cm, more preferably at most 5 mm, and being larger than 0.5 mm, preferably larger than 1 mm. The air flow channel extends in an upward direction between an air entrance and an air exit. The first and second walls are made of a thermally conductive material. Thus, the air flow channel is configured as an air cooling element.

It is to be noted that additional air cooling element may be provided to at least one of the plurality of housings. For example, ventilation slits or aerating vents comprised in a wall of the at least one of the plurality of housings may allow for air to be renewed within said housing and thereby improve dissipation of heat.

In embodiments of the lighting apparatus, the plurality of housings defines different modules of the lighting apparatus. The different modules may be similar or different in terms of dimensions, contained components, and/or composing materials. However, the first wall of the first housing and the second wall of the second housing facing each other are made of a thermally conductive material, preferably metal, more preferably aluminum. In other words, heat generated by electronic components and accumulating within the first housing and the second housing can be transferred out of the first housing and the second housing through the first wall and the second wall, respectively.

Thanks to the air flow channel defined via the spacing means, the heat being transferred in the space between the first wall and the second wall can be evacuated, thusly promoting the cooling of the first housing and the second housing. It is to be noted that the inner arrangement of the electronic components within the first housing and/or the second housing may be organized such that electronic components generating a higher level of heat may be placed closer to a thermally conductive wall neighboring the air flow channel. The dimension of the air flow channel in at least one direction perpendicular to the air flow may be restricted, and the air flow channel extends in an upward direction in order for natural air convection to occur. Such a design increases the efficiency of the air cooling. At the same time, due to the slanted, or vertical, orientation of the air flow channel, dust and water do not accumulate, keeping the effectivity of the air cooling intact as time passes.

The spacing means may comprise one or more spacing elements. Spacing elements may be arranged within the air flow channel between the first wall and the second wall to maintain a predetermined distance between them and/or may be arranged at at least one end of the air flow channel. For example, the one or more spacing elements may comprise a first common end plate arranged at a first end of the first and second housings and a second common end plate arranged at a second end of the first and second housings.

Depending on the profile of the first wall and/or of the second wall, the dimension of the air flow channel in at least one direction perpendicular to the air flow may be constant or may vary. Using the spacing means, the air flow channel is created in a simple manner reducing production costs respective to specifically designed air channels.

Additionally, the one or more spacing elements may comprise one or more adjustable spacing elements. In that way, the minimum distance between the first wall and the second wall may be adapted to the surrounding environment, more particularly depending on temperature and humidity levels of the surrounding environment. Optionally, the first housing and/or the second housing comprises at least one temperature sensor to measure temperature within the respective housing and/or of the ambient temperature outside the respective housing; and the one or more adjustable spacing elements may be controlled through a motorized means comprised by the lighting apparatus so that the air flow channel dimensions are adjusted in function of the temperature(s) measured.

Alternatively, the one or more spacing elements may comprise one or more adjustable spacing elements such as to provide a variety of adjusting options during commissioning and/or assembly of the lighting apparatus. For example, an end plate for closing the first housing and the second housing may comprise a plurality of mounting positions for the first housing and the second housing to provide for different air channel dimensions depending on a desired usage.

The lighting apparatus may be adapted for outdoor lighting or industrial lighting. By outdoor lighting and industrial lighting, it is meant lighting adapted for roads, tunnels, industrial plants, stadiums, airports, harbors, rail stations, campuses, parks, cycle paths, pedestrian paths, or pedestrian zones for example, and industrial and outdoor lighting systems can be used notably for the lighting of an outdoor area, such as roads and residential areas in the public domain, private parking areas and access roads to private building infrastructures, warehouses, industry halls, etc.

According to a preferred embodiment, the second housing accommodates a driving means configured for driving the at least one lighting unit.

In this manner, different heat-generating electronic components are separated in different housings, decreasing the rate at which heat accumulates within individual housings while using a common heat evacuation means, the air flow channel.

It is to be noted that the second housing may also comprise at least one lighting unit. In addition, the driving means may be connected to the at least one lighting unit of the first housing, and optionally to the at least one lighting unit of the second housing, via a connecting line passing through cable glands in the first housing and the second housing such that sealing is maintained at the level of the connecting line. Alternatively, cable passages may be arranged in the end plates, see further.

In an embodiment, a first electronic component, e.g. the at least one lighting unit, generating more heat than a second electronic component, e.g. the driving means, may be located close to a thermally conductive wall neighboring the air flow channel, e.g. the first wall, having a larger surface than another thermally conductive wall, e.g. the second wall, located close to the second electronic component.

According to another aspect, there is provided a modular system. The modular system comprises: a plurality of housings, and a spacing means. The plurality of housings comprises a first housing having a first wall and a second housing having a second wall. The first wall faces said second wall. At least one electronic component is provided to the first housing, preferably in the first housing. At least one another electronic component is provided to the second housing. The spacing means is configured for arranging said first wall at a distance of said second wall such that an air flow channel is defined between the first wall and the second wall, a minimum distance between the first wall and the second wall being at most 3 cm, preferably at most 1 cm, more preferably at most 5 mm, and being larger than 0.5 mm, preferably larger than 1 mm. The air flow channel extends in an upward direction between an air entrance and an air exit. The first and second walls are made of a thermally conductive material. Thus, the air flow channel is configured as an air cooling element.

The at least one and at least one another electronic components may be any kind of components, wherein at least one component thereof generates heat. Thus, the invention can also be used for other components different from a lighting unit and/or a driving means. All embodiments disclosed above for the lighting apparatus also apply to the present modular system, and vice versa. The skilled person will understand that some of the below embodiments are equally applicable to the lighting apparatus and the modular system.

According to an exemplary embodiment, the first wall and the second wall are arranged to face each other over an area, A, which is larger than 300 cm².

In this way, the area A defining facing walls of the air flow channel may be sufficiently large to be configured for cooling below a predetermined temperature the electronic components within the first housing and the second housing.

Additionally or alternatively, the spacing means may be designed such that portions of the air flow channel defined between the first wall and the second wall have different dimensions with respect to each other in order to more efficiently evacuate dust, water, or debris depending on the portion. Also, as seen in a cross-section perpendicular to the length of the first and second wall, the first wall and the second wall may be converging in the first section looking in the downstream direction.

According to a preferred embodiment, the air flow channel has a length, l, and a width, w, perpendicular to the length, said width extending in a flow direction of the air flow channel, said length being longer than said width, wherein preferably said length is between 20 and 120 cm, and wherein preferably said width is between 5 and 30 cm.

In an embodiment, the first and second walls may define the air flow channel over their entire corresponding surfaces and the first wall and the second wall have a length, l, and a width, w, perpendicular to the length, said width extending in a flow direction of the air flow channel, said length being longer than said width. Preferably said length is between 20 and 120 cm, and preferably said width is between 5 and 30 cm.

In this manner, the width of the air flow channel is restricted such that upward circulation of air is kept along a relatively short distance, thereby allowing substantially quick renewal of the air contained within the air flow channel. Additionally, the length of the air flow channel being longer than its width, a substantially large area for heat exchange is created.

In an embodiment, the air flow channel may have a varying width along its length in function of the heat generated by the electronic component directly facing a corresponding portion. That is, a first portion of the thermally conductive wall defining the air flow channel and facing a first electronic component may be designed to delimit the air flow channel over a larger width than a second portion of the thermally conductive wall defining the air flow channel and facing a second electronic component, said first electronic component generating more heat than said second electronic component.

According to an exemplary embodiment, the distance between the first wall and the second wall increases in a first section when looking in a downstream direction from the air entrance to the air exit, such that a Venturi effect is created.

In this way, air circulation is promoted, which increases the efficiency of the air cooling by having faster circulation of air. Depending on the profiles of the first wall and the second wall, the distance between the first and second walls in the first section may be increasing linearly or non-linearly. In an embodiment, an outer surface profile of the first wall and/or the second wall over the first section may be straight. In another embodiment, the outer surface profile of the first wall and/or the second wall over the first section may be convex or concave.

Additionally, the first wall and the second wall may be designed in order to take advantage of the Coanda effect which may be used such that dust, debris, and water entering in the air flow channel is evacuated efficiently.

According to a preferred embodiment, the distance between the first and the second walls decreases in a second section when looking in the downstream direction, said second section being upstream of the first section.

In this manner, the Venturi effect and the Coanda effect may be accentuated. In an embodiment, the outer surface profile of the first wall and/or the second wall over the second section may be straight. In another embodiment, the outer surface profile of the first wall and/or the second wall over the second section may be convex or concave. Also, seen in a cross-section perpendicular to the length of the first and the second wall, the outer surface profile of the first wall and/or the second wall may be first converging in the second section and next diverging in the first section, looking in the downstream direction.

According to an exemplary embodiment, a portion of the first wall and/or a portion of the second wall has a convex outer surface as seen in a cross-section along the flow direction.

Preferably, the portion of the first wall has a convex outer surface arranged symmetrically with respect to the portion of the second wall having a convex outer surface as seen in a section along the flow direction, i.e. in a cross-section perpendicular to length of the air flow channel.

In this way, the design complexity of the first housing and/or the second housing is lessened and the modularity can be increased. Indeed, this allows using the same housing for the first and the second housings.

According to a preferred embodiment, the first housing and the second housing each comprises an elongate profile with a length direction extending preferably perpendicular to the flow direction in the air flow channel.

In this manner, the lighting apparatus may be better adapted to be installed as a suspended lighting apparatus. Preferably, in embodiments in which the spacing means comprises a plurality of end plates, the lighting apparatus may be suspended by the end plates.

Preferably the first housing and/or the second housing comprises parts made by extrusion.

In an embodiment, an upper part of the first housing may be made by extrusion, preferably in aluminum, and may be optionally completed by a lower part in a transparent or translucent material allowing light emitted by the at least one lighting unit to pass through; for the second housing, both an upper part and a lower part may be made by extrusion.

Additionally, the spacing means may comprise end plates provided to both extremities of the elongate profiles such as to arrange the first housing at a predetermined distance from the second housing. The first housing and the second housing may be similar in shapes or different.

According to an exemplary embodiment, the first wall and the second wall are an elongate first side wall of the first housing and an elongate second side wall of the second housing, respectively.

In this way, the first housing and the second housing may be placed substantially parallel to each other. In an embodiment, both the first housing and the second housing may have the same length.

According to a preferred embodiment, the first housing and the second housing each comprises an extruded profile.

In this manner, production costs can be decreased.

In alternative embodiments, the first housing and/our the second housing may be made by die-casting or by folding sheet metal.

Preferably, the first housing and the second housing each comprises a substantially V-shaped or an arc-shaped extruded profile. When installing the lighting apparatus, the first housing and/or the second housing may be arranged such as to have the narrow end of its extruded profile pointing upward; thus, dirt, debris, or water can more easily be evacuated by gravity.

According to an exemplary embodiment, the first and the second housings comprise each at least one extruded profile having a similar shape, preferably being identical.

In this way, the modularity of the lighting apparatus may be improved and the overall design made simpler. The plurality of housings may be used individually and may be arranged with similar or different orientations. Housings with a similar shape may have similar or different functionalities and may be made out of similar or different materials.

It is to be noted that, even in the case of a plurality of housings arranged with similar orientations, lighting units with different orientations may be provided to each of the plurality of housings.

According to a preferred embodiment, the first housing comprises a first substantially V-shaped profile and the second housing comprises a second substantially V-shaped profile, and the second profile is oriented such as to have a corner pointing upwards and the first profile is oriented such as to have a corner pointing upward.

In this manner, evacuation of dirt, water, and debris is facilitated by the first housing and by the second housing. Indeed, presenting a corner upwardly, both the first housing and the second housing present faces exposed to dirt, water, and debris at an angle easing the work of gravity, in opposition to a face oriented horizontally for example. Also, due to the substantially V-shape of the first profile and of the substantially V-shape of the second profile, the air flow channel can easily be formed using the first and the second profiles oriented in different directions.

In an embodiment, both the first housing and the second housing may comprise similarly shaped V-shaped profiles. For the second housing, two V-shaped profiles may be arranged with their open end facing each other to form an enclosure, each of the substantially V-shaped profiles defining half of the second housing, thereby forming a substantially lozenge-shaped housing. The first housing may comprise a single substantially V-shaped profile, optionally closed by a cover, e.g. a transparent or translucent cover.

According to an exemplary embodiment, the spacing means comprises an end plate, wherein the end plate is configured for being fixed to an end of the first housing and an end of the second housing.

In a preferential embodiment, the first housing and the second housing each comprises an elongate profile with a length direction extending preferably perpendicular to the flow direction in the air flow channel in a plane substantially parallel to the first wall and/or the second wall, and the end plate closes an end of the first housing and/or an end of the second housing, preferably both ends of the first housing and the second housing.

In this way, the end plate can serve the double duty of maintaining a predetermined distance between the first housing and the second housing, as well as closing, at least partially, the extremities of the first and/or second housings. The overall design is simplified by the use of multipurpose parts. In an embodiment, the spacing means may also comprise additional elements provided within the air flow channel, between the first wall and the second wall.

According to a preferred embodiment, the end plate comprises at least one passage configured for receiving an electrical power cabling.

In an embodiment, the at least one passage may also be provided with a cable gland surrounding the electrical power cabling to maintain the sealing at the level of the passage.

According to an exemplary embodiment, the lighting apparatus further comprises:
a third housing comprising a third wall;
the second housing comprising another second wall, said another second wall facing the third wall;
at least one electronic component, preferably another lighting unit, being provided to the third housing, preferably in the third housing;
wherein the spacing means is further configured for arranging said another second wall at a distance of the third wall such that another air flow channel is defined between the another second wall and the third wall, a minimum distance between the another second wall and the third wall being at most 3 cm, preferably at most 1 cm, more preferably at most 5 mm, and being larger than 0.5 mm, preferably larger than 1 mm, said another air flow channel extending in an upward direction between an air entrance and an air exit;
wherein said another second and third walls are made of a thermally conductive material.

The another air flow channel is configured as another air cooling element.

In this manner, the lighting apparatus is easily scalable while still providing for additional cooling means. In an embodiment, a driving means may be provided to the second housing and may be configured for driving the at least one lighting unit of the first housing, and optionally the at least one electronic component, preferably the another lighting unit, of the third housing.

Depending on embodiments, the at least one electronic component comprises one or more among the following;
a camera unit;
a laser device;
a radar device;
a microphone;
a movement detector;
a light emitting device such as an ultraviolet (UV) light or an infrared (IR) light or a light for light fidelity (Li-Fi) communication;
a panic button;
a pollution sensor;
a visibility sensor;
a sound sensor;
a temperature sensor;
a spraying/sanitizing device;
power management circuitry;
telecommunication circuitry, such as base station circuitry;
audio system management circuitry;
a display;
an antenna;
WiFi circuitry, wherein an antenna for receiving WiFi signals may be integrated either in the third housing or in a separate antenna module;
charger circuitry, e.g. phone charger circuitry or vehicle charger circuitry;
an environmental sensor such as a microphone, or a detector of CO2, NOx, smoke, etc., and the associated circuitry;
a human interface device (HID) and the associated circuitry, e.g. a camera, a loudspeaker, a button, a touch screen, etc.
repeater circuitry, e.g. a WiFi repeater;
a sign, such as a publicity banner;
a water discharge device, such as a shower head, a sprinkler, a water sprayer, etc;
a trash bin;
a socket, such as an electrical socket.

It is to be noted that the plurality of housings is not limited to comprise only a first housing, a second housing, and a third housing, but may also include even more housings. The skilled person will understand that the spacing means may be configured in consequence to arrange the plurality of housings with respect to each other such that additional air flow channels are defined. The additional air flow channels may have the same or different dimensions.

According to an exemplary embodiment, the first, second and third housings each comprises an elongate profile with a length direction extending preferably perpendicular to the flow direction in the air flow channel in a plane substantially parallel to the first wall, the second wall, the another second wall, and/or the third wall.

In this way, the lighting apparatus can easily be augmented using additional housings in a transversal direction perpendicular to the length direction.

According to a preferred embodiment, the first, second, another second, and third walls are an elongate first side wall of the first housing, a first and second elongate second side walls of the second housing, and an elongate first side wall of the third housing, respectively.

According to an exemplary embodiment, the first housing and the third housing are arranged along a first arrangement level, and the second housing is arranged along a second arrangement level above the first arrangement level as seen in a plane perpendicular to the length direction.

Preferably, the second housing is shaped, and especially the second wall with respect to the another second wall, such as to be substantially complementary to the space defined by the first wall of the first housing and the third wall of the third housing.

By arrangement level, it is meant a horizontal virtual line passing through a geometric center of the housing it is associated with, as seen in the plane perpendicular to the length direction. So, the first housing and the third housing are substantially aligned on a first horizontal line representing the first arrangement level while the second housing is arranged higher vertically in the lighting apparatus such that its geometric center is above this first horizontal line, on a second horizontal line representing the second arrangement level.

In this manner, longer air flow channels may be defined using a multi-levelled arrangement to improve a cooling efficiency of the air cooling elements thusly formed, and the lighting apparatus can be made modular in both vertical and transversal directions.

The skilled person will understand that the lighting apparatus may be formed by housings arranged along more than two levels while still allowing air flow channels to be defined by the spaces left between the different housings.

According to a preferred embodiment, the at least one lighting unit comprises a first lighting unit provided to the first housing and a second lighting unit provided to the third housing. Also, the second housing accommodates the driving means configured for driving the at least one lighting unit.

In this way, the housings of the lighting apparatus arranged along the first level and facing a surface to be illuminated are used in lighting functions, while other housings arranged on higher levels are used for functions other than lighting functions.

According to an exemplary embodiment, the plurality of housings comprises at least five housings arranged to define four air flow channels, or even seven housings arranged to define six air flow channels. In another embodiment, the plurality of housings comprises at least four housings arranged to define two air flow channels.

According to a preferred embodiment, the lighting apparatus is configured to be suspended.

For example, the spacing means may comprise end plates fixed at the extremities of the first and second housings and the lighting apparatus may be suspended by the end plates.

In this manner, a space may be maintained between the air exit and a point from which the lighting apparatus is suspended, allowing heated air from the air flow channel to mix with ambient cooler air.

In an alternative embodiment, the lighting apparatus may be integrated in a casing of the ceiling, and the casing is configured to allow air ventilation for heated air evacuated from the air flow channel to dissipate.

According to an exemplary embodiment, the at least one lighting unit is an LED lighting unit.

In this way, one can obtain light emitted from the at least one lighting unit with a high intensity, suitable for providing a desired visibility level in a given environment, for example in a large hall, while having a substantially low power consumption. In an embodiment, there may be a plurality of LEDs per lighting unit.

According to a preferred embodiment, the first housing comprises a transparent or translucent lower cover, and the LED lighting unit is arranged within the first housing to face the transparent or translucent lower cover.

In this manner, the LED lighting unit may be protected within the enclosure of the first housing, the transparent or translucent lower cover corresponding to a lower part of the first housing.

According to an exemplary embodiment, the at least one lighting unit is provided with a thermal dissipation means within the first housing.

The thermal dissipation means may comprise a heat sink. In this way, cooling of the at least one lighting unit may be achieved more directly and in a targeted manner.

Preferably, the lighting unit comprises a support carrying a plurality of LEDs, wherein the support is arranged parallel to the transparent or translucent lower cover.

According to a third aspect of the invention, there is provided a modular lighting apparatus. The modular lighting apparatus comprises at least a first, a second, a third and a fourth substantially V-shaped elongate profiles. At least one of the first and the second V-shaped elongate profiles, preferably both, houses a light source, and optionally a transparent or translucent cover closes the V-shaped profile. The third and fourth V-shaped elongate profiles are combined with their open sides facing each other so as to form a housing for one or more other components, such as a driving means of the light source. In a mounted state, the first and the second elongate profiles are arranged parallel to each other with their open side oriented downward, and the combination of the third and the fourth elongate profiles is arranged in between the first and the second elongate profiles with the open side of the third elongate profile oriented upward, such that a first wall of the third elongate profile faces a second wall of the first elongate profile and such that a second wall of the third elongate profile faces a first wall of the second elongate profile. The first wall of the third elongate profile and the facing second wall of the first elongate profile define a first air flow channel configured as a first air cooling element. The second wall of the third elongate profile and the facing first wall of the second elongate profile define a second air flow channel configured as a second air cooling element.

According to a preferred embodiment, the first, second, third, and fourth elongate profiles have similar shapes, preferably identical shapes. These elongate profiles may be made by extrusion, preferably in metal, more preferably in aluminum.

According to an exemplary embodiment, the modular lighting apparatus comprises a spacing means configured for arranging the first wall of the third elongate profile at a first distance of the second wall of the first elongate profile, and for arranging the second wall of the third elongate profile at a second distance of the first wall of the second elongate profile, such as to define a first air flow channel and a second air flow channel, respectively. Preferably, each of the first distance and the second distance is at most 3 cm, preferably at most 1 cm, more preferably at most 5 mm, and is larger than 0.5 mm, preferably larger than 1 mm. Preferably, each of the first air flow channel and the second air flow channel extends in an upward direction between an air entrance and an air exit. The air entrance of the first air flow channel may correspond to the air entrance of the second air flow channel. The first and second walls of the third elongate profile, at least the first wall of the second elongate profile, and at least the second wall of the first elongate profile are made of a thermally conductive material. Preferably, the entire first, second, and third elongate profiles are made of a thermally conductive material.

In an embodiment, the spacing means comprises a first end plate and a second end plate. The first end plate is configured for being fixed to first extremities of the first, second, third, and fourth elongate profiles. The second end plate is configured for being fixed to other opposite extremities of the first, second, third, and fourth elongate profiles.

According to a preferred embodiment, the modular lighting apparatus further comprises a fifth and a sixth substantially V-shaped elongate profile. The fifth and the sixth elongate profiles are arranged next to the first and the second elongate profiles, respectively. Preferably the fifth and the sixth elongate profiles each comprises at least one light source.

Additionally, the first end plate and the second end plate may be configured for also being fixed to both extremities, respectively, of the fifth and sixth elongate profiles. The first and second end plate may be configured for fixing each of the fifth and sixth elongate profiles in a plurality of orientations as seen in a cross-section of the elongate profiles, such that light emitted by the at least one light source of the fifth and/or sixth elongate profile is oriented towards a desired direction, e.g. downward, or preferably upward to further allow up-light.

Optionally, the first and the second end plates may be completed with an end housing, preferably and end housing extending along the first extremities of all elongates profiles, such end housing may accommodate one or more cables and/or one or more additional components such as sensors.

According to a fourth aspect, there is provided a suspended modular lighting apparatus. The suspended modular lighting comprises at least two, preferably at least three, substantially V-shaped elongate profiles arranged parallel to each other between two end plates. Each substantially V-shaped elongate profile accommodates a light source. A first profile of said at least two elongate profiles is rotated with respect to a second profile of said at least two elongate profiles such that an orientation of a light beam emitted by the light source accommodated in the first profile is different from an orientation of a light beam emitted by the light source accommodated in the second profile. In an embodiment, the first profile is oriented such that its light source emits light substantially downwardly while the second profile is oriented oppositely of the first profile such that its light source emits light substantially upwardly.

Features of the different aspects and preferred features discussed above may be combined in any possible way.

### BRIEF DESCRIPTION OF THE FIGURES

This and other aspects of the present invention will now be described in more detail, with reference to the appended drawings showing a currently preferred embodiment. Like numbers refer to like features throughout the drawings.

FIGS. 1A-1B show schematically a perspective view of an exemplary embodiment of a lighting apparatus and a close-up view of an air flow channel, respectively, according to the invention;

FIGS. 2A-2D illustrate cross-sectional views of exemplary embodiments of lighting apparatuses according to the invention;

FIG. 3A-3C shows a cross-sectional view of another exemplary embodiment of a lighting apparatus according to the invention, as well as close-up alternative cross-sectional views, respectively;

FIGS. 4A-4C depict a side-view, a cross-sectional view, and an exploded perspective view, respectively, of yet another exemplary embodiment of a lighting apparatus according to the invention;

FIG. 5 shows schematically a perspective view of still another exemplary embodiment of a lighting apparatus according to the invention;

FIG. 6 shows a cross-sectional view of yet another exemplary embodiment of a lighting apparatus;

FIGS. 7A-7B illustrate a cross-sectional view and an exploded perspective view, respectively, of another exemplary embodiment of a lighting apparatus according to the invention;

FIG. 8 illustrates an exploded perspective view of a lighting housing of another exemplary embodiment of a lighting apparatus according to the invention;

FIGS. 9A-9B illustrate a cross-sectional view and an exploded perspective view, respectively, of another exemplary embodiment of a lighting apparatus according to the invention;

FIG. 10 illustrates an exploded perspective view of another exemplary embodiment of a lighting apparatus according to the invention;

FIG. 11 illustrates an exploded perspective view of another exemplary embodiment of a lighting apparatus according to the invention;

FIG. 12 illustrates an exploded perspective view of another exemplary embodiment of a lighting apparatus according to the invention.

### DESCRIPTION OF EMBODIMENTS

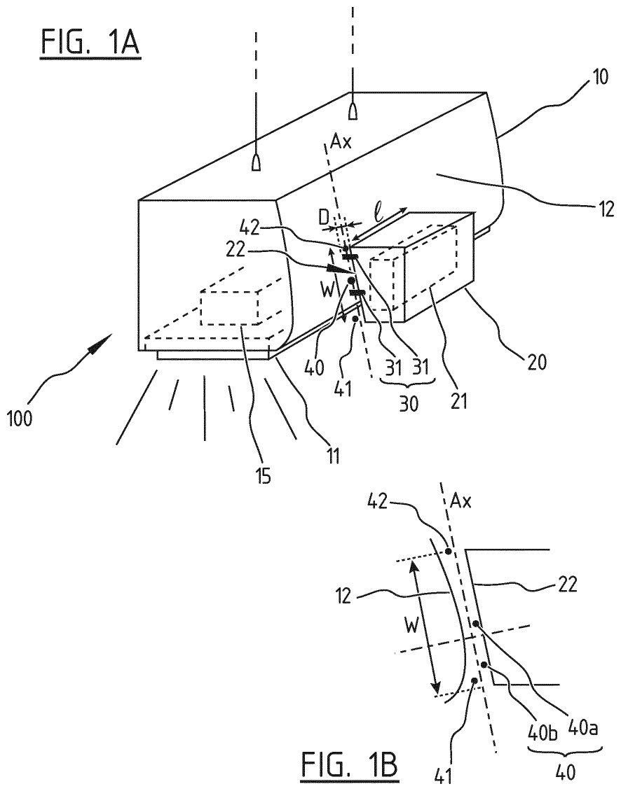

FIGS. 1A-1B show schematically a perspective view of an exemplary embodiment of a lighting apparatus and a close-up view of an air flow channel, respectively, according to the present invention. The lighting apparatus 100 may be adapted for outdoor lighting or industrial lighting. By outdoor lighting and industrial lighting, it is meant lighting adapted for roads, tunnels, industrial plants, stadiums, airports, harbors, rail stations, campuses, parks, cycle paths, pedestrian paths, or pedestrian zones for example, and industrial and outdoor lighting systems can be used notably for the lighting of an outdoor area, such as roads and residential areas in the public domain, private parking areas and access roads to private building infrastructures, warehouses, industry halls, etc.

The lighting apparatus 100 comprises: a plurality of housings 10, 20, at least one lighting unit 11, and a spacing means 30. The plurality of housings comprises a first housing 10 having a first wall 12 and a second housing 20 having a second wall 22. The first wall 12 faces said second wall 12.

The plurality of housings 10, 20 may define different modules of the lighting apparatus 100. The different modules may be similar or different in terms of dimensions, contained components, and/or composing materials. In the embodiment of FIG. 1A, the first housing 10 and the second housing 20 are different and have different dimensions. The first wall 12 and the second wall 12 are made of a thermally conductive material, preferably metal, more preferably aluminum.

The spacing means 30 is configured for arranging said first wall 12 at a distance of said second wall 22 such that an air flow channel 40 is defined between the first wall 12 and the second wall 22. The air flow channel 40 is configured as an air cooling element for the lighting apparatus 100. Preferably, a minimum distance between the first wall 12 and the second wall 22 is at most 3 cm, preferably at most 1 cm, more preferably at most 5 mm, and is larger than 0.5 mm, preferably larger than 1 mm. The air flow channel 40 extends in an upward direction between an air entrance 41 and an air exit 42. In the embodiment of FIG. 1A, the spacing means 30 comprises one or more spacing elements, more particularly a pair of spacing elements 31 at each end of the second housing 20. The spacing elements 31 are arranged within the air flow channel 30 between the first wall 12 and the second wall 22 to maintain a predetermined distance between them.

Depending on an outer surface profile of the first wall 12 and/or of the second wall 22, the dimension of the air flow channel 40 in at least one direction perpendicular to the air flow may be constant or may vary. A portion of the first wall 12 and the second wall 22 delimiting the air flow channel 40 may be defined by a length, l, and a width, w, perpendicular to the length, said width extending in a flow direction, Ax, of the air flow channel 40, said length being longer than said width. Preferably said length 1 is between 20 and 120 cm, and preferably said width w is between 5 and 30 cm. The first wall 12 and the second wall 22 may be arranged to face each other over an area, A (A=1*w), which is larger than 300 cm².

In the embodiment of FIGS. 1A-1B, the cross-sections of the air flow channel 40 along its length have constant dimensions, and the cross-sections of the air flow channel 40 along its width have varying dimensions between the air entrance 41 and the air exit 42. More particularly, as can be seen in FIG. 1B, the distance between the first wall 12 and the second wall 22 increases over a first section 40a when looking in a downstream direction such that a Venturi effect is created. Also, the distance between the first wall 12 and the second wall 22 decreases over a second section 40a upstream of the first section when looking in a downstream direction. The outer surface profile of the first wall 12 is convex, while the outer surface profile of the second wall is straight. Depending on embodiments, the outer surface profile of the first wall and/or the second wall may be straight, convex or concave.

In an embodiment, portions of the thermally conductive wall 12, 22 defining the air flow channel 40 may have varying areas in function of the heat generated by the electronic component 11, 21 directly facing a corresponding portion. That is, a first portion of the thermally conductive wall defining the air flow channel 40 and facing a first electronic component may be designed to have a larger effective heat dissipating area, e.g. by having a patterned outer surface with ridges or embossed, than a second portion of the thermally conductive wall defining the air flow channel 40 and facing a second electronic component, said first electronic component generating more heat than said second electronic component. Additionally or alternatively, the spacing means 30 may be designed such that portions of the air flow channel 40 between the first wall and the second wall have different dimensions in order to more efficiently evacuate dust, water, or debris dependent on the portion.

The first housing 10 and the second housing 20 each comprises an elongate profile with a length direction extending preferably perpendicular to the flow direction in the air flow channel 40 in a plane substantially parallel to the first wall 12 and/or the second wall 22. So, the first wall 12 and the second wall 22 are an elongate first side wall of the first housing 10 and an elongate second side wall of the second housing 20, respectively. Both the first housing 10 and the second housing 20 of FIG. 1A have a four-sided cross-section. The first housing 10 is longer than the second housing 20 in the embodiment of FIG. 1A. In another embodiment, the first housing 10 may have the same length as the second housing 20. Additionally, the first housing 10 and the second housing 20 may have the same cross-sections.

The at least one lighting unit 11 is provided to the first housing 10; the first housing 10 may be provided with an opening on its lower face, said opening configured for arranging the at least one lighting unit 11 within. The at least one lighting unit 11 may be an LED lighting unit. The at least one lighting unit 11 may also be provided with a thermal dissipation means within the first housing 10, a heat sink 15 on top of the at least one lighting unit 11 in the embodiment of FIG. 1A. The second housing 20 accommodates a driving means 21 configured for driving the at least one lighting unit 11. The driving means 21 may be connected to the at least one lighting unit 11 via a connecting line (not shown) passing through cable glands in the first housing 10 and in the second housing 20 such that sealing is maintained at the level of the connecting line. The first housing 10 of FIG. 1A may be made entirely of a thermally conductive material. In another embodiment, only the first wall 12 is made of a thermally conductive material. The second housing 20 of FIG. 1A completely encloses the driving means 21 and may be made entirely of a thermally conductive material. In another embodiment, only the second wall 22 is made of a thermally conductive material.

It is to be noted that first housing 10 and/or the second housing 20 may be provided with other electronic components. The inner arrangement of the electronic components within the first housing 10 and/or the second housing 20 may be organized such that electronic components generating a higher level of heat may be placed closer to a thermally conductive wall neighboring the air flow channel 40.

The lighting apparatus 100 may be adapted to be installed as a suspended lighting apparatus. In the embodiment of FIG. 1A, a suspension means is provided to two points of the first housing 10.

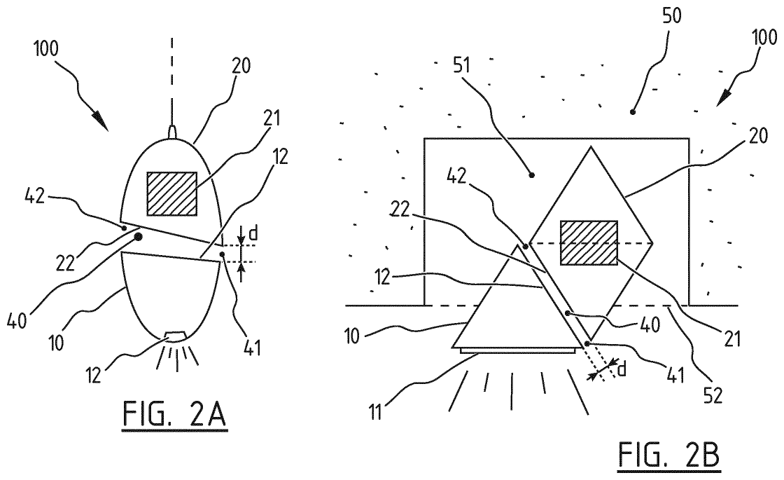

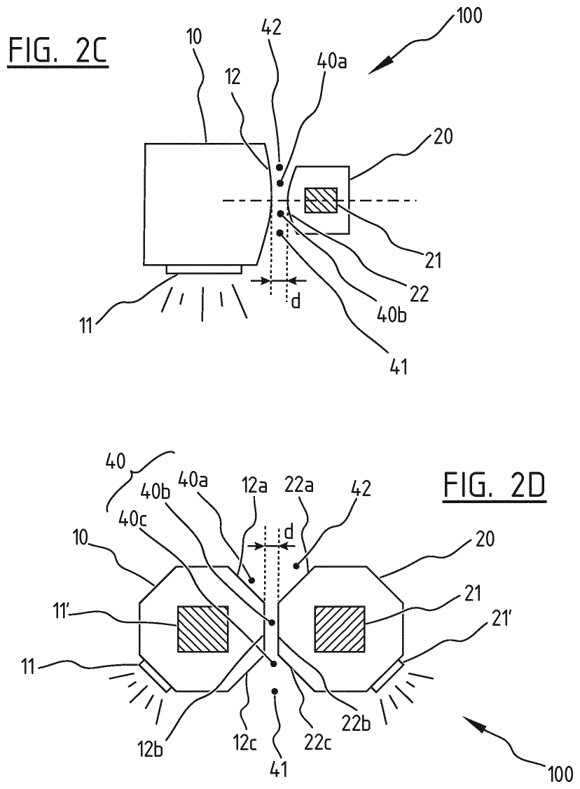

FIGS. 2A-2D illustrate cross-sectional views of exemplary embodiments of lighting apparatuses according to the present invention.

The first housing 10 and the second housing 20 in the embodiments of FIGS. 2A-2D may each comprise an extruded profile in a thermally conductive material, preferably metal, more preferably aluminum. For the sake of simplicity, the spacing means is not illustrated.

In the embodiment of FIG. 2A, the first housing 10 and the second housing 20 have each an arc-shaped profile closed by a flat wall. The first housing 10 comprises a first wall 12 facing a second wall 12 of the second housing 20. The flat wall of the first housing 10 makes the first wall 12. The flat wall of the second housing 20 makes the second wall 12. The second housing 20 is arranged such as to have its narrow end of the arc pointing upward. The first housing 10 is arranged such as to have its narrow end of the arc pointing downward. The first wall 12 and the second wall 22 define an air flow channel 40 extending upward at an angle between an air entrance 41 and an air exit 42. The air flow channel 40 is configured as an air cooling element. A distance between the first wall 12 and the second wall 22 increases from a minimum distance d when looking in a downstream direction from the air entrance 41 to the air exit 42 such that a Venturi effect is created. At least one lighting unit 11 is provided to the first housing 10. The at least one lighting unit 11 may be arranged within a recess of the first housing 10. A transparent or translucent cover (not shown), defining a lower part of the first housing 10, may be provided over the recess such as to protect the at least one lighting unit 11. A driving means 21 configured for driving the at least one lighting unit 11 is provided to the second housing 20.

In the embodiment of FIG. 2B, the first housing 10 comprises a housing part having a substantially V-shaped profile with an open end. The second housing 20 comprises two housing parts having a substantially V-shaped profile with an open end. The two housing parts used for the second housing 20 may be similar to the one used for the first housing 10. The first housing 10 is provided with at least one lighting unit 11 and may be completed by a lower part in a transparent or translucent material allowing light emitted by the at least one lighting unit 11 to pass through. The two housing parts of the second housing 20 are arranged such that their respective open ends correspond. A sealing gasket may be provided between the two housing parts of the second housing 20. A driving means 21 configured for driving the at least one lighting unit 11 is provided to the second housing 20. The first housing 10 is oriented such that the narrow end of the substantially V-shaped profile is upward. The second housing 20 is oriented to also have a narrow end of a substantially V-shaped profile pointing upward. The substantially V-shaped profile of the housing parts may be made in a thermally conductive material. The walls of the first housing 10 and the second housing 20 facing each other are a first wall 12 of the first housing and a second wall 22 of the second housing defining an air flow channel 40 between them. The first housing 10 and the second housing 20 may be arranged such that a minimum distance d between the first wall 12 and the second wall 22 is constant when looking in a downstream direction from an air entrance 41 to an air exit 42. The lighting apparatus 100 of FIG. 2B is provided to a recess 51 in a ceiling 50. The recess 51 in the ceiling is closed by a venting plate 52 surrounding the lighting apparatus, thereby allowing ambient air to circulate to and from the recess 51. The air flow channel 40 is slanted with an air entrance 41 outside the recess 51 and an air exit 42 within the recess 51.

In the embodiment of FIG. 2C, the first housing 10 and the second housing 20 have each a four-sided cross-section. The cross-section of the first housing 10 is larger than the cross-section of the second housing 20. At least one lighting unit 11 is provided to the first housing 10. A driving means 21 configured for driving the at least one lighting unit 11 is provided to the second housing 20. The first housing 11 comprises a first wall 12 facing a second wall 22 of the second housing. The first wall 12 and the second wall 22 have each a convex outer surface profile defining an air flow channel 40a, 40b. The air flow channel 40a, 40b can thus be separated in a first section 40a and a second section 40b, said first section 40a being downstream with respect to a point of the air flow channel where a distance d is at its minimum, and said second section 40b being upstream with respect to the point of the air flow channel wherein the distance d is at its minimum. In the first section 40a, the distance between the first wall 12 and the second wall 22 increases when looking in a downstream direction from an air entrance 41 to an air exit 42. In the second section 40b, the distance between the first wall 12 and the second wall 22 decreases when looking in a downstream direction from the air entrance 41 to the air exit 42. The air flow channel 40a, 40b is oriented substantially vertically.

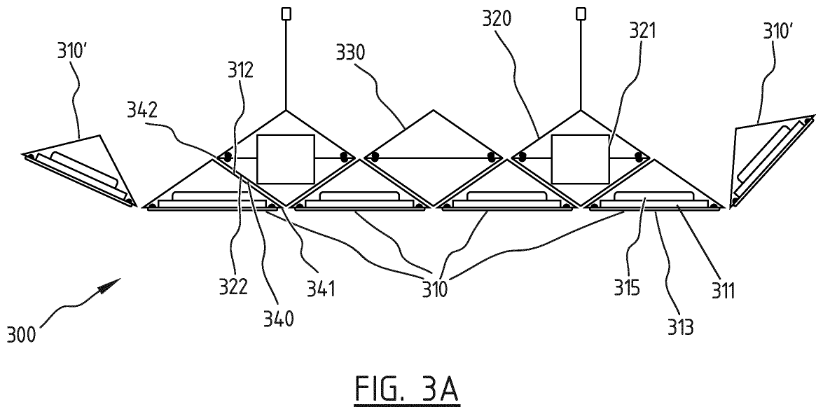

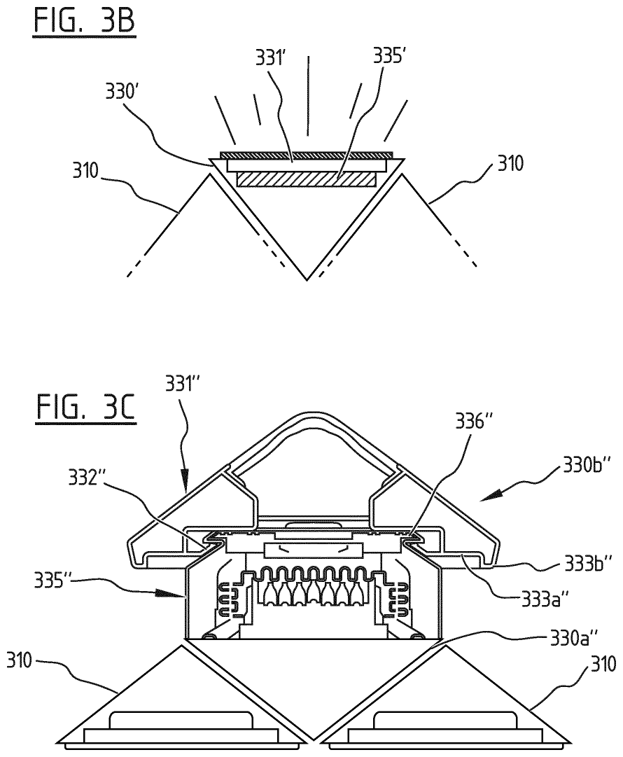

In the embodiment of FIG. 2D, the first housing 10 and the second housing 20 have each an octagonal cross-section of similar dimensions. Each of the first housing 10 and the second housing 20 is provided with at least one lighting unit 11, 21′ and a driving means 11′, 21, respectively. The first housing 10 comprises a first wall 12a, second wall 12b, and third wall 12c, facing a fourth wall 22a, a fifth wall 22b, and a sixth wall 22c, respectively, of the second housing 20. The first to sixth wall 12a-12c, 22a-22c define an air flow channel 40 oriented substantially vertically having a first, a second, and a third section 40a, 40b, 40c. A minimum distance d between the second wall 12b and the fifth wall 22b in the second section 40b is constant when looking in a downstream direction from an air entrance 41 to an air exit 42. The first section 40a and the third section 40c define funnels oriented in opposite directions such that a Venturi effect is created within the air flow channel 40 The main lighting directions of the at least one lighting unit 11, 21′ of the first housing and the second housing may be symmetrical with respect to the air flow channel 40. FIGS. 3A-3C show a cross-sectional view of another exemplary embodiment of a lighting apparatus according to the present invention, as well as close-up alternative cross-sectional views, respectively. The lighting apparatus 300 comprises a plurality of housings 310, 310′, 320, 330. The plurality of housings 310, 310′, 320, 330 may comprise a plurality of lighting housings 310, 310′ a plurality of functional housings 320, and a dummy housing 330.

Each of the plurality of lighting housings 310, 310′ may be provided with at least one lighting unit 311 as well as a heat sink 315 arranged on top of the at least one lighting unit 311. Each of the plurality of functional housings 320 may be provided with a functional electronic component, e.g. a driving means 321. For example, each of the plurality of functional housings 320 may be provided with a driving means 321 configured for driving a plurality of lighting units. The dummy housing 330 may be an empty housing. Alternative embodiments of the dummy housing 330 are described with respect to FIGS. 3B and 3C.

In the embodiment of FIG. 3A, the plurality of housings 310, 310′, 320, 330 may comprise one or more substantially V-shaped elongated profiles made by extrusion. The substantially V-shaped elongated profiles may be made in a thermally-conductive material, preferably metal, more preferably aluminum. The substantially V-shaped elongated profiles may have an open end.

In the case of the plurality of lighting housings 310, 310′, the open end may be closed by a lower part 313 made in a translucent or transparent material to allow light emission from the at least one lighting unit 311 provided therein. In the case of the plurality of functional housings 320 and the dummy housing 330, two substantially V-shaped elongated profiles may be arranged such that their respective open ends correspond, each of the two substantially V-shaped elongated profiles composing half of the housing. A sealing gasket may be provided between the two substantially V-shaped elongated profiles of the housing 320, 330.

The plurality of lighting housings 310, 310′ comprises a plurality of central lighting housings 310 and a plurality of extremity lighting housings 310′. Each of the plurality of central lighting housings 310 is oriented such that a lighting direction of the at least one lighting unit 311 is substantially vertical. A narrow end of the substantially V-shaped elongated profile of each of the plurality of central lighting housings 310 is oriented upward. In the embodiment of FIG. 3A, the plurality of lighting housings 310, 310′ comprises four central lighting housings 310 and two extremity lighting housings 310′. The four central lighting housings 310 are arranged next to each other. Each of the two extremity lighting housings 310′ is oriented away from the plurality of central lighting housings 310, one at each opposite extremity of the neighboring central lighting housings 310.

The plurality of functional housings 320 and the dummy housing 330 are oriented similarly. The housings 320, 330 are oriented such that a narrow-end of a V-shaped elongated profile comprised in each of the housings 320, 330 is upside-down relative to the V-shaped profiles of the plurality of lighting housings 310, 310′. Each of the plurality of central lighting housings 310 comprises at least one first wall 312 facing at least one second wall of each of the plurality of functional housings 320 and the dummy housing 330.

A spacing means (not shown) is configured for arranging each of the plurality of first walls 312 at a distance of each of the plurality of second walls 322 such that a plurality of air flow channels 340 is defined between the plurality of first walls 312 and the plurality of second walls 322, a minimum distance between each of the plurality of first walls 312 and each of the plurality of second walls 322 being at most 3 cm, preferably at most 1 cm, more preferably at most 0.5 cm, and being larger than 0.5 mm, preferably larger than 1 mm. Each of the plurality of air flow channels 340 extends in an upward direction between an air entrance 341 and an air exit 342, and is configured as an air cooling element. In the embodiment of FIG. 3A, each of the plurality of first walls 312 and each of the plurality of second walls 322 is straight. The distance between each of the plurality of first walls 312 and the plurality of second walls 322 is constant when looking in a downstream direction from the air entrance 341 to the air exit 342.

The spacing means of FIG. 3A may comprise a first end plate and a second end plate. Each of the first end plate and the second end plate may be fixed at each of opposite extremities, respectively, of the plurality of housings 310, 310′, 320, 330. Optionally, the first and second end plates are configured for fixing each of the extremity lighting housings 310′ in a plurality of orientations as seen in a cross-section of the elongate profiles, such that light emitted by the light sources 344 of the extremity lighting housings 310′ are each oriented towards a desired direction. For example, in the embodiment of FIG. 3A, the extremity lighting housing 310′ on the right is oriented at a larger angle relative to a horizontal line than the extremity lighting housing 310′ on the left.

The lighting apparatus 300 may be configured for being suspended. With the spacing means holding the plurality of housings 310, 310′, 320, 330 together, the lighting apparatus 300 may be suspended with suspending means connected at different points of the plurality of functional housings 320.

FIG. 3B shows an alternative close-up cross-sectional view of the dummy housing 330 of FIG. 3A according to the present invention. In the embodiment of FIG. 3B, the dummy housing 330 of FIG. 3A is replaced by an upward lighting housing 330′. Neighboring central lighting housings 310 of FIG. 3B are similar to the central lighting housings 310 of FIG. 3A. The upward lighting housing 330′ is similar to the central lighting housings 310 of FIG. 3A apart that it is oriented upwardly. The skilled person will understand that the implementation of the upward lighting housing 330′ is not limited only to the embodiment of FIG. 3B and that it can be adapted to other embodiments according to the invention.

FIG. 3C shows another alternative close-up cross-sectional view of the dummy housing 330 of FIG. 3A according to the present invention. In the embodiment of FIG. 3C, the dummy housing 330 of FIG. 3A is replaced by a trunking housing 330a″, 330b″. Neighboring central lighting housings 310 of FIG. 3C are similar to the central lighting housings 310 of FIG. 3A. The trunking housing 330a″, 330b″ comprises a lower housing part 330a″ and an upper housing 330b″. The lower housing part 330a″ is similar to the lower housing part of the dummy housing 330 of FIG. 3A. The upper housing 330b″ of FIG. 3C comprises an upper housing part and an upper portion of a lower housing part according to the embodiments described in patent application NL2024250. The skilled person will understand that the implementation of the trunking housing 330a″, 330b″ is not limited only to the embodiment of FIG. 3C and that it can be adapted to other embodiments according to the invention.

The lighting apparatus implemented with the trunking housing 330a″, 330b″ of FIG. 3C may be used in a lamp trunking system. The lamp trunking system may comprises a plurality of elongate units, each of the plurality of elongate units comprising the trunking housing 330a″, 330b″ of FIG. 3C and configured for being mechanically and electrically interconnected to one another via at least one of their respective extremities. In the embodiment of FIG. 3C, the upper housing 330b″ comprises an upper housing part 331″ and an upper portion 335″ of a lower housing part, the upper portion 335″ being completed by the lower housing part 330a″. The upper portion 335″ comprises therein a plurality of electrical wirings running along its length. The upper housing part 331″ may be mountable on the upper portion 335″. The upper housing part 331″ may be glued, screwed, bolted, and/or mechanically engaged with the upper portion 335″.

In the embodiment of FIG. 3C, the top of the upper portion 335″ comprises a pair of outward protrusions 336″. The bottom of the upper housing part 331″ comprises a pair of guiding surfaces 332″ along its length. In the embodiments of FIG. 3C, the pair of guiding surfaces 332″ is extending inwardly and upwardly. The pair of guiding surfaces 332″ may be configured for being mountable to the pair of elongate outward protrusions 336″, e.g. by sliding and guiding, snap-fitting. The pair of elongate outward protrusions 336″ may define a substantially downward-facing groove within which the pair of guiding surfaces 332″ will be lodged when mounted. By mounting the upper housing part 331″ along the length of the upper portion 335″, such that the pair of guiding surfaces 332″ is lodged behind the pair of elongate outward protrusions 336″, the upper portion 335″ and the upper housing part 331″ can be mechanically engaged. Usually, the pair of elongate outward protrusions 336″ has a maximum width, as measured across the section of the upper portion 335″, lower than 0.5 cm.

The upper housing part 331″ may delimit one or more separate compartment distinct from a compartment delimited by the upper portion 335″ and the lower housing part 330a″, a central compartment and two side compartments in the embodiment of FIG. 3C. The top surface of the upper housing part 331″ is substantially V-shaped. The bottom of the upper housing part 331″ may comprise a pair of elongate outward protruding portions forming the pair of sliding surfaces 333a″. The pair of sliding surfaces 333a″ are configured for cooperating with a pair of supporting sliding elements such that the elongate unit temporarily arranged on the pair of supporting sliding element can be slid along its length. The width of each of the pair of sliding surfaced 333a″, as measured across its cross-section, is higher than 0.5 cm, preferably higher than 1 cm. The pair of elongate outward protruding portions may further comprise a pair of elongate downward protrusions 333b″ forming a drop-edge of the pair of sliding surfaces 333a″. The pair of elongate downward protrusions 333b″ is located along the length of the elongate unit outer surface. The pair of drop-edges 333b″ may prevent accumulation of dirt and create a safe dripping point for falling water droplets. It can also result in a better guidance of the pair of supporting sliding elements cooperating with the pair of sliding surfaces 333a″. The pair of elongate outward protruding portions may further be configured for cooperating with a retaining means of a suspension means. Indeed the elongate unit may be suspended from an external support via a plurality of suspension means. The suspension mean may comprise the retaining means, a support fixation means, and a connecting means connecting the support fixation means to the retaining means.

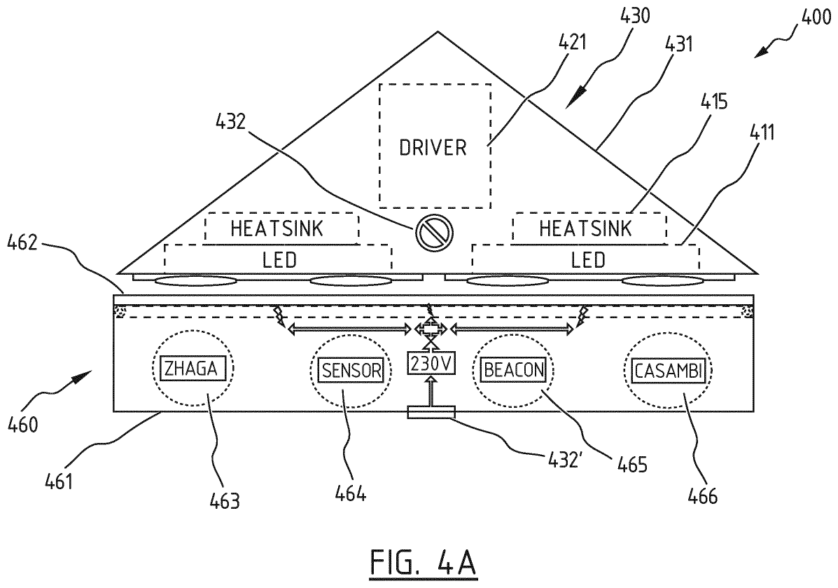

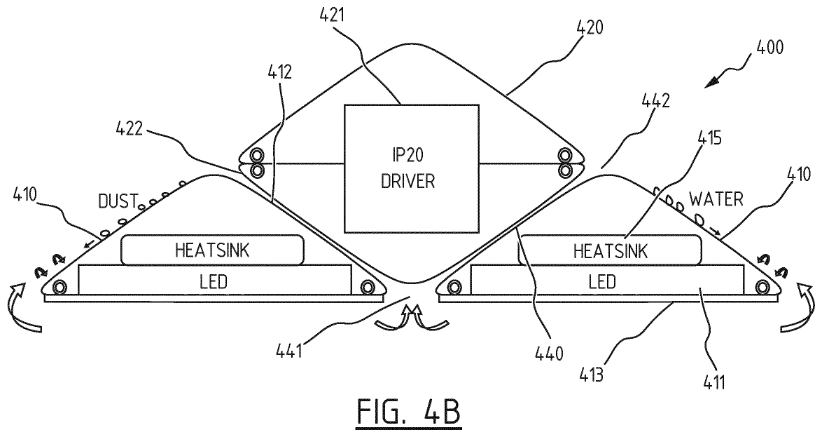

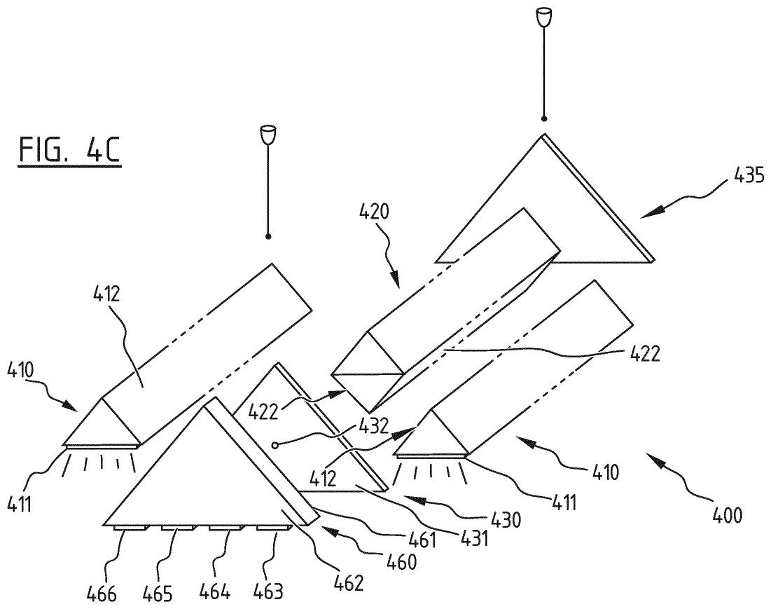

FIGS. 4A-4C depict a side-view, a cross-sectional view, and an exploded perspective view, respectively, of yet another exemplary embodiment of a lighting apparatus according to the present invention. The lighting apparatus 400 comprises a plurality of housings 410, 420. The plurality of housings 410, 420 in FIGS. 4A-4C comprises two lighting housings 410 with at least one lighting unit 411 each as well as a heat sink 415 provided to it, and one functional housing 420 with a driving means 421 configured for driving both of the at least one lighting unit 411. The two lighting housings 410 and the functional housing 420 are similar to the corresponding housings described with respect to FIG. 3A aside from the shape of their outer surfaces. Each outer surface of the V-shaped elongated profiles has a symmetrical convex surface when looking in a downstream direction from an air entrance 441 to an air exit 442 of the plurality of air flow channels 440, as depicted in the exemplary embodiment of FIG. 4B.

A spacing means 430 in FIG. 4A and FIG. 4C comprises a first end plate 431 and a second end plate 435 (shown in FIG. 4C) opposite thereof. The spacing means 430 is configured for arranging each of the plurality of first walls 412 at a distance of each of the plurality of second walls 422 such that a plurality of air flow channels 440 is defined between the plurality of first walls 412 and the plurality of second walls 422, a minimum distance between each of the plurality of first walls 412 and each of the plurality of second walls 422 being at most 3 cm, preferably at most 1 cm, more preferably at most 0.5 cm, and being larger than 0.5 mm, preferably larger than 1 mm. Each of the first end plate 431 and the second end plate may be fixed at each end of the plurality of housings 410, 420. Each of the plurality of air flow channels 440 extends in an upward direction between the air entrance 441 and the air exit 442, and is configured as an air cooling element. The air entrance 441 in FIG. 4B is common to the plurality of air flow channels 440. The first end plate 431 comprises at least one passage 432 configured for receiving an electrical power cabling. Additionally, the at least one passage may also be provided with a cable gland surrounding the electrical power cabling to maintain the sealing at the level of the passage. The separation between each of the plurality of first walls 412 and the plurality of second walls 422 is constant across a length of the air flow channels 440.

FIG. 4A also depicts a top view of a functional module for a lighting apparatus according to the invention. The functional module 460 of FIG. 4A comprises a front plate 462 and a back plate 461. The front plate 462 and the back plate 461 may have a similar shape as the first end plate 431 and the second end plate 435 of the lighting apparatus such that, when the front plate 462 of the functional module is fixed to the first end plate 431 of the lighting apparatus, the profile of the lighting apparatus 400 is prolonged. The functional module 460 may comprise a twist-lock socket 463, e.g. NEMA, Zhaga, a sensing means 464, a signaling means 465, a communication means, and/or a controlling means 466. The functional module 460 may comprise a housing wall, e.g. back plate 461, made of a RF-transparent material, e.g. plastic. The functional module 460 may be powered in a similar manner as the lighting apparatus 400 and the electrical power cabling passing through the passage 432 of the first end plate 431 may pass through a corresponding passage 432′ of the back plate similarly equipped with a cable gland for sealing purposes.

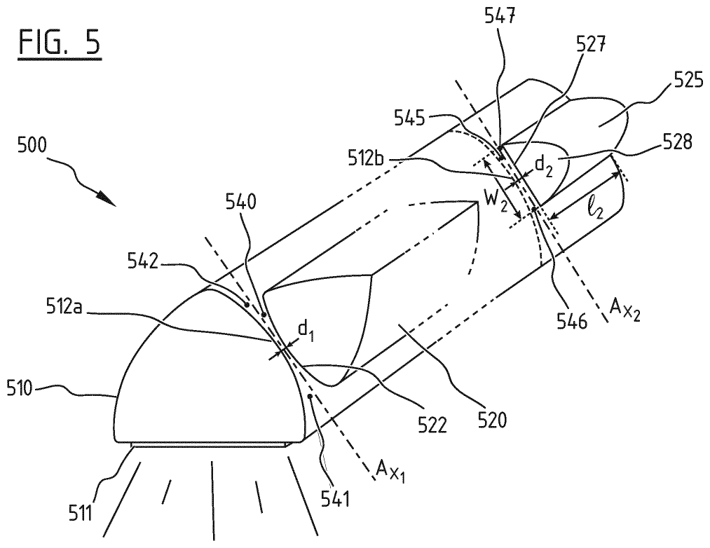

FIG. 5 shows schematically a perspective view of still another exemplary embodiment of a lighting apparatus according to the present invention. The lighting apparatus 500 comprises: a plurality of housings 510, 520, 525, at least one lighting unit 511, and a spacing means (not shown). The plurality of housings 510, 520, 525 of FIG. 5 comprises a first elongate housing 510 having a first wall 512a, 512b, a second elongate housing 520 having a second wall 522, and a third elongate housing 525 having a third wall 527. A first portion 512a of the first wall faces said second wall 522 and a second portion 512b of the first wall faces said third wall 527. The first housing 510 is provided with the at least one lighting unit 511. The second housing 520 is provided with a driving means (not shown) configured for driving the at least one lighting unit 511.

The first wall 512a, 512b, second wall 522, and third wall 527 are made of a thermally conductive material. In the embodiment of FIG. 5, the outer surface profile of the first wall 512a, 512b is convex; the outer surface profile of the second wall 522 is convex; and the outer surface profile of the third wall 527 is straight. Additionally, air flow channels may be defined by a length and a width. In the case of the second air flow channel 545, the second portion 512b of the first wall and the third wall 527 have a length l₂ and a width w₂, said width extending in a second flow direction Ax₂ of the second air flow channel 545, said length l₂ being longer than said width w₂. Preferably, said length l₂ is between 20 and 120 cm, and preferably said width w₂ is between 5 and 30 cm.

A spacing means (not shown) is configured for arranging said first wall 512a, 512b at a distance of said second wall 522, and at a distance of said third wall 527. The spacing means of FIG. 5 comprises end plates fixed respectively to extremities of the first housing 510 and the second housing 520, and extremities of the first housing 510 and the third housing 530. The spacing means of FIG. 5 also comprises additional spacing elements between the first portion 512a of the first wall and the second wall 522, and between the second portion 512b of the first wall and the third wall 527.

A first air flow channel 540 is defined between the first portion 512a of the first wall and the second wall 522. The first air flow channel 540 extends upwardly, at an angle in FIG. 5, between a first air entrance 541 and a first air exit 542, and is configured as a first air cooling element. A second air flow channel 545 is defined between the second portion 512b of the first wall and the third wall 527. The second air flow channel 545 extends upwardly, at an angle in FIG. 5, between a second air entrance 546 and a second air exit 547, and is configured as a second air cooling element. The first air flow channel 540 extends along a first flow direction Ax₁ and the second air flow channel 545 extends along the second flow direction Ax₂. The first flow direction Ax₁ and the second flow direction Ax₂ may be the same or different. Both the first air flow channel 540 and the second air flow channel 545 may be designed in order to take advantage of the Venturi effect.

A minimum distance d₁ between the first portion 512a of the first wall and the second wall 522 is at most 3 cm, preferably at most 1 cm, more preferably at most 5 mm, and is larger than 0.5 mm, preferably larger than 1 mm. A minimum distance d₂ between the second portion 512b of the first wall and the third wall 527 is at most 3 cm, preferably at most 1 cm, more preferably at most 5 mm, and is larger than 0.5 mm, preferably larger than 1 mm. Minimum distances d₁ and d₂ may be the same or different. These differences may be due to different requirements in the cooling required for electronic components provided to the second housing 520 or the third housing 525, different materials composing the second housing 520 or the third housing 525, and/or different profiles of the second wall 522 and the third wall 527.

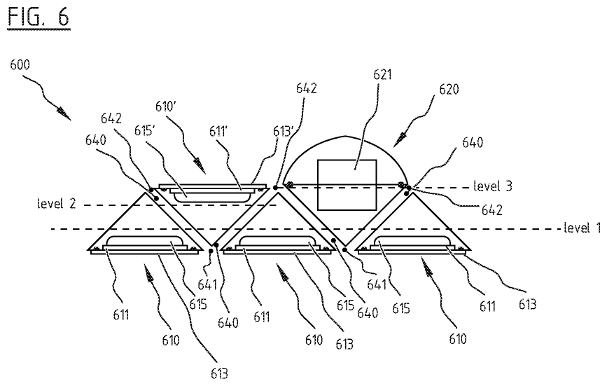

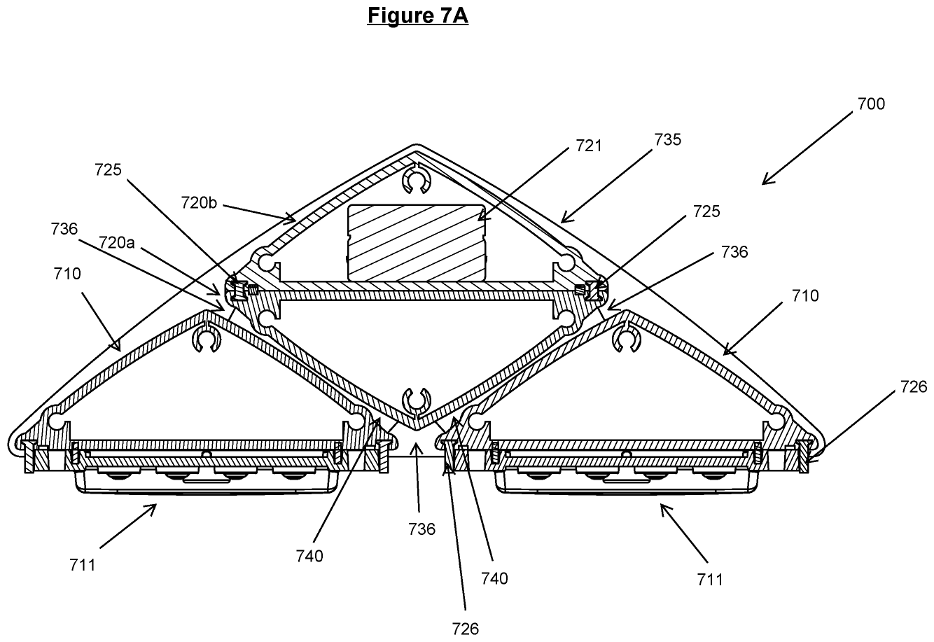

Optionally, the second housing 520 has a fourth wall (not shown), corresponding to one of its extremities, facing a fifth wall 528 at an extremity of the third housing 525. Both the fourth wall and the fifth wall 528 are made of a thermally conductive material and define another air flow channel extending upwardly. FIG. 6 shows a cross-sectional view of yet another exemplary embodiment of a lighting apparatus according to the present invention. The lighting apparatus 600 comprises a plurality of housings 610, 610′, 620. The plurality of housings 610, 610′, 620 may comprise a plurality of lighting housings 610, 610′ and a functional housing 620.

Each of the plurality of lighting housings 610, 610′ may be provided with at least one lighting unit 611, 611′ as well as a heat sink 615, 615′ arranged on top of the at least one lighting unit 611, 611′. The functional housing 620 may be provided with a functional electronic component, e.g. a driving means 621. For example, the functional housing 620 may be provided with a driving means 621 configured for driving the plurality of lighting units 611, 611′.

In the embodiment of FIG. 6, the plurality of housings 610, 610′, 620 may comprise one or more substantially V-shaped elongated profiles made by extrusion. The substantially V-shaped elongated profiles may be made in a thermally-conductive material, preferably metal, more preferably aluminum. The substantially V-shaped elongated profiles may have an open end.

In the case of the plurality of lighting housings 610, 610′, the open end may be closed by a lower part 613, 613′ made in a translucent or transparent material to allow light emission from the at least one lighting unit 611, 611′ provided therein. In the case of the functional housing 620, two substantially elongated profiles, a V-shaped profile and an arc-shaped profile, may be arranged such that their respective open ends correspond, each of the V-shaped profile and the arc-shaped profile composing half of the functional housing 620. A sealing gasket may be provided between the two elongated profiles of the functional housing 620.

A spacing means (not shown) is configured for arranging each of the plurality of first walls at a distance of each of the plurality of second walls such that a plurality of air flow channels 640, four air flow channels in the embodiment of FIG. 6, is defined between the plurality of first walls and the plurality of second walls, a minimum distance between each of the plurality of first walls and each of the plurality of second walls being at most 3 cm, preferably at most 1 cm, more preferably at most 0.5 cm, and being larger than 0.5 mm, preferably larger than 1 mm. Each of the plurality of air flow channels 640 extends in an upward direction between an air entrance 641 and an air exit 642 and is configured as an air cooling element. In the embodiment of FIG. 6, each of the plurality of first walls and each of the plurality of second walls is straight. The distance between each of the plurality of first walls and the plurality of second walls is constant when looking in a downstream direction from the air entrance 641 to the air exit 642.

The plurality of lighting housings 610, 610′ comprises a plurality of downward illuminating lighting housings 610 and an upward illuminating lighting housing 610′. Each of the plurality of downward illuminating lighting housings 610 is oriented such that a lighting direction of the at least one lighting unit 611 is substantially vertical and facing down. A narrow end of the substantially V-shaped elongated profile of each of the plurality of downward illuminating lighting housings 610 is oriented upward. The three downward illuminating lighting housings 610 are arranged next to each other in the embodiment of FIG. 6.

The upward illuminating lighting housing 610′ is oriented such that a lighting direction of the at least one lighting unit 611′ is substantially vertical and facing up. A narrow end of the substantially V-shaped elongated profile of the upward illuminating lighting housing 610′ is oriented downward. Two of the plurality of downward illuminating lighting housings 610 comprises at least one first wall facing at least one second wall of the upward illuminating lighting housing 610′. More specifically, the upward illuminating lighting housing 610′ is arranged such as to complement the space defined between two of the three downward illuminating lighting housings 610.

The functional housing 620 is oriented such that a narrow-end of the V-shaped profile comprised in it is upside-down relative to the V-shaped profiles of the plurality of downward illuminating lighting housings 610. Two of the plurality of downward illuminating lighting housings 610 comprises at least one first wall facing at least one second wall of the functional housing 620. More specifically, the functional housing 620 is arranged such as to complement the space defined between two of the three downward illuminating lighting housings 610. Additionally, three levels of arrangement can be distinguished between the plurality of housings 610, 610′, 620 of the lighting apparatus 600: level 1, level 2, and level 3. By arrangement level, it is meant a horizontal virtual line passing through a geometric center of the housing it is associated with, as seen in the plane perpendicular to the length direction. In the embodiment of FIG. 6, the plurality of downward illuminating lighting housings 610 are substantially aligned on a first horizontal line representing the first arrangement level (or level 1), while the upward illuminating lighting housing 610′ is arranged higher vertically in the lighting apparatus 600 on a second horizontal line representing the second arrangement level (or level 2) such that its geometric center is above this first horizontal line, and the functional housing 620 is arranged even higher vertically in the lighting apparatus 600 on a third horizontal line representing the third arrangement level (or level 3) such that its geometric center is above the first and second horizontal lines.

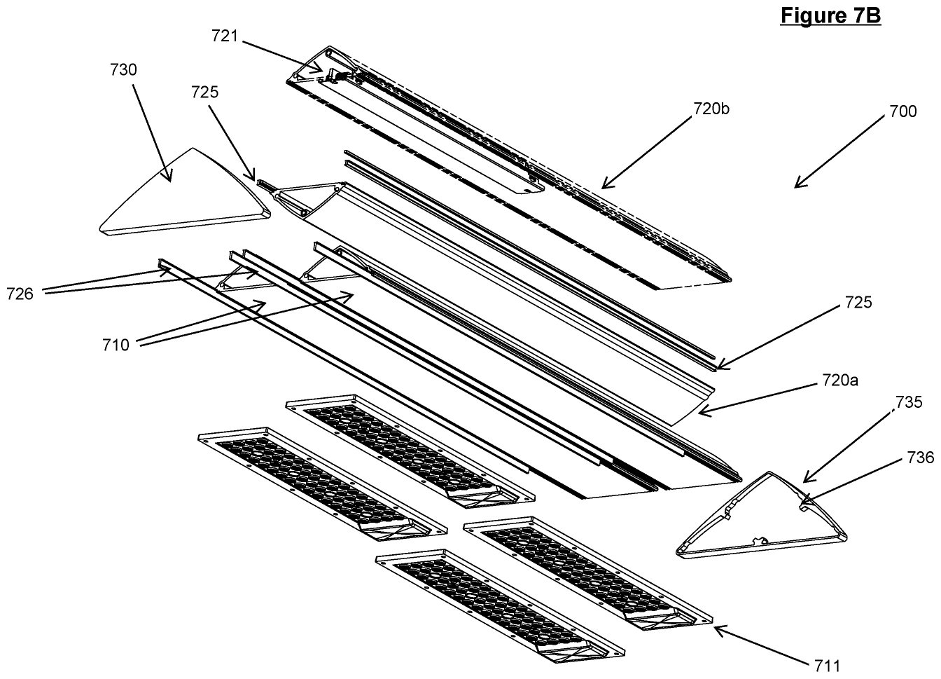

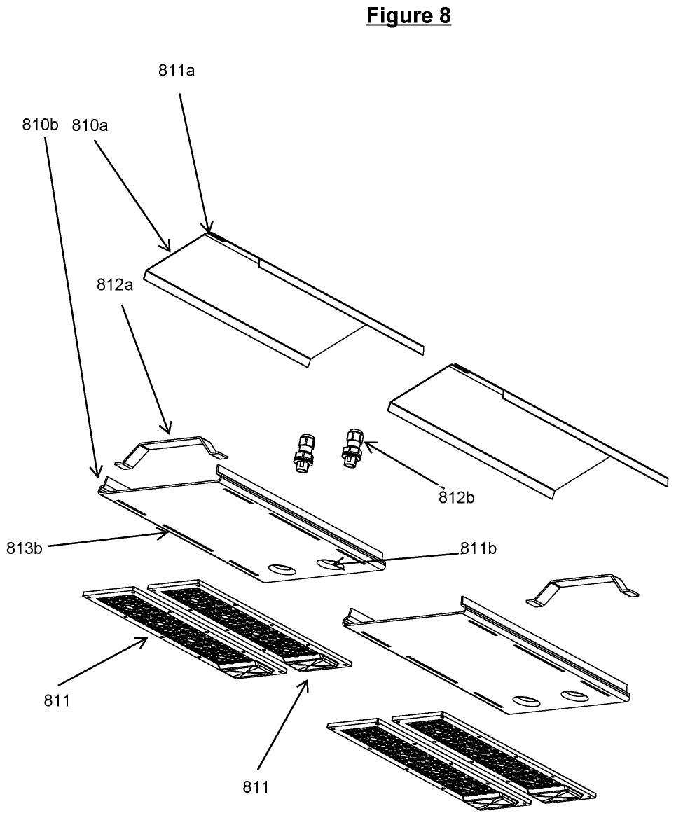

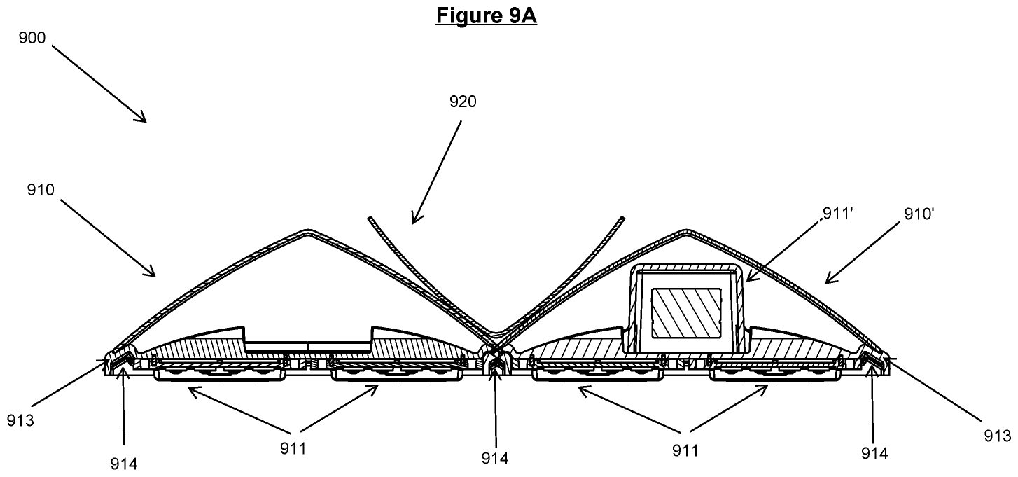

FIGS. 7A-7B illustrate a cross-sectional view and an exploded perspective view, respectively, of another exemplary embodiment of a lighting apparatus according to the present invention. The lighting apparatus 700 comprises a plurality of housings 710, 720a, 720b. The plurality of housings 710, 720a, 720b may comprise a plurality of lighting housings 710 and a functional housing 720a, 720b.

Each of the plurality of lighting housings 710 may be provided with at least one lighting unit 711. The functional housing 720 may be provided with a functional electronic component, e.g. a driving means 721. For example, the functional housing 720 may be provided with a driving means 721 configured for driving the plurality of lighting units 711.

In the embodiments of FIGS. 7A-7B, the plurality of housings 710, 720a, 720b may comprise one or more substantially V-shaped elongated profiles made by extrusion. The substantially V-shaped elongated profiles may be made in a thermally-conductive material, preferably metal, more preferably aluminum. The substantially V-shaped elongated profiles may define closed profiles with a closed bottom end.

In the case of the plurality of lighting housings 710, the closed bottom end may be provided with the at least one lighting unit 711 in thermal contact thereof such as to dissipate the heat from the at least one lighting unit 711 during light emission. At least one optical element, two pair of louver elements 726 in the embodiments of FIGS. 7A-7B, may be provided within rails on each side of the lighting housings 721 as seen in the longitudinal direction, said rails extending along each side of the at least one lighting unit 711. The two pair of louver elements 726 are configured for blocking light rays emitted by the at least one lighting unit 711 above a predefined angle in order to avoid glaring light.

In the case of the functional housing 720a, 720b, two substantially elongated profiles, in FIGS. 7A-7B two V-shaped profiles 720a, 720b similar to the ones used for the plurality of lighting housings 710, may be arranged such that their respective closed bottom ends correspond, each of the two V-shaped profiles 720a, 720b composing half of the functional housing 720a, 720b. Thus, two distinct and separate compartments are created by each of the two V-shaped profiles 720a, 720b of the functional housing. The driving means 721 is arranged within one V-shaped profile 720b of the functional housing 720a, 720b. A joining element 725 provided within rails on each side of the functional housing 720a, 720b as seen in the longitudinal direction may be provided between the two V-shaped profiles 720a, 720b of the functional housing to attach the two V-shaped profiles 720a, 720b together. A sealing gasket (no shown) may also be arranged at the interface between them.

A first end plate 730 and a second end plate 735 comprise a first spacing means (not shown) and a second spacing means 736, respectively. More specifically, in the embodiment of FIG. 7B, the first end plate 730 and the second end plate 735 each comprises indents facing extremities of the plurality of housings 710, 720a, 720b. By arranging the plurality of housings 710, 720a, 720b within the indents, the plurality of housings 710, 720a, 720b are spaced from each other by the protruding first spacing means and second spacing means 736 between them, such that a plurality of air flow channels 740, two air flow channels 740 in the embodiment of FIG. 7A, are created.

FIG. 8 illustrates an exploded perspective view of a lighting housing of another exemplary embodiment of a lighting apparatus according to the present invention.

The lighting housing 810a, 810b of FIG. 8 may comprise an upper housing 810a and a lower housing 810b configured for cooperating with each other. The upper housing 810a and the lower housing 810b define a substantially elongate housing with a V-shaped profile. The V-shaped profile has a closed bottom end.

The lighting housings 810a, 810b may be provided with at least one lighting unit 811, two side-by-side lighting units 811 in the embodiment of FIG. 8. The lighting units 811 are mounted against the closed bottom end of the lower housing 810b such as to be in thermal contact thereof. Both the upper housing 810a and the lower housing 810b may be made of metal, more particularly sheet metal, and formed by folding.

The lighting units 811 may electrically connect to additional components using electrical connecting means passing within through-holes 811b of the lower housing 810b and using at least one connector 812b fitted to the corresponding through-hole 811b.

Additionally, in the embodiment of FIG. 8, a plurality of ventilation slits 813 cut within the closed bottom end of the lower housing 810b allows for additional air flow to cool down the lighting housing 810a, 810b.

A suspension fixation 812a may be arranged within the lighting housing 810a, 810b and mounted to the lower housing 810b. The suspension fixation 812a is configured for cooperation with a suspension means (not shown), e.g. a suspension cable, passing through a corresponding suspension slit 811a of the upper housing 810a such as to enable suspension of the lighting housing 810a, 810b.

The skilled person will understand that, as illustrated in the embodiment of FIG. 8, multiple lighting housings 810 may be arranged in line in a modular manner.

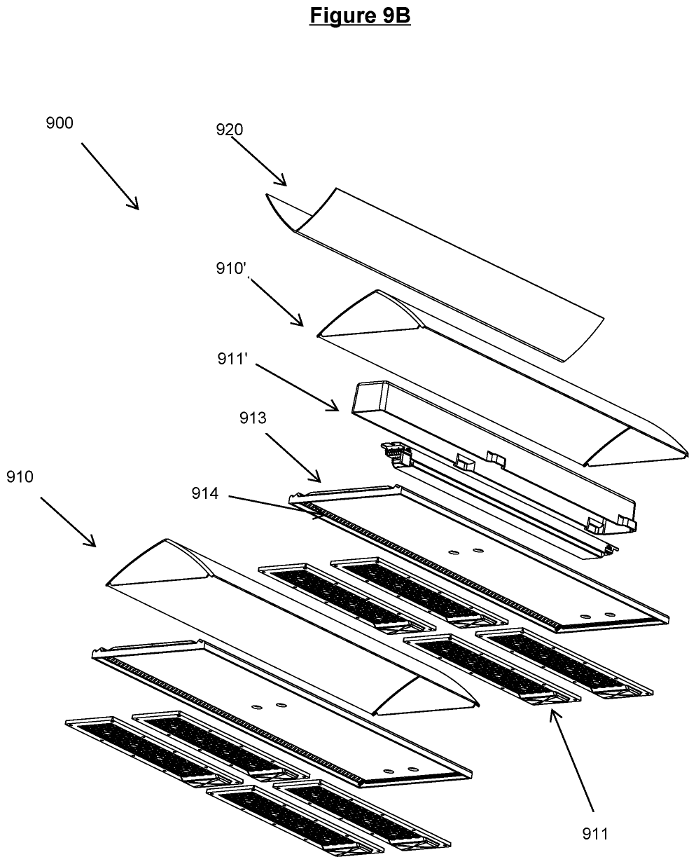

FIGS. 9A-9B illustrate a cross-sectional view and an exploded perspective view, respectively, of another exemplary embodiment of a lighting apparatus according to the present invention. The lighting apparatus 900 comprises a plurality of housings 910, 910′, 920. The plurality of housings 910, 910′, 920 may comprise a plurality of lighting housings 910, 910′ and a cooling housing 920.

Each of the plurality of lighting housings 910, 910′ may be provided with at least one lighting unit 911. At least one of the lighting housings 910′ may also be provided with a functional electronic component, e.g. a driving means 911′ configured for driving the plurality of lighting units 911.

In the embodiments of FIGS. 9A-9B, the plurality of housings 910, 910′, 920 may comprise one or more substantially V-shaped elongated profiles made by die-casting. The substantially V-shaped elongated profiles may be made in a thermally-conductive material, preferably metal, more preferably aluminum. The substantially V-shaped elongated profiles may define open profiles with an open end. More specifically, as illustrated in the embodiment of FIG. 9B, the plurality of lighting housings 910, 910′ may be formed with closed extremities, while the cooling housing 920 may be formed with open extremities. Alternatively, the cooling housing 920 may be made by extrusion or folding sheet metal. In another embodiment, the cooling housing 920 may be made from plastic.

In the case of the plurality of lighting housings 910, 910′, the open end may be closed by a lower part 913 shaped as a tray onto which at least one lighting unit 911 is provided, four lighting units 911 in the embodiment of FIG. 9B in a 2×2 array. In the embodiments of FIGS. 9A-9B, there is one lower part 913 provided to each of the plurality of lighting housings 910, 910′. In another embodiment, a single lower part may be provided to at least two lighting housings 910, 910′ of the plurality of light housings 910, 910′.

The driving means 911′ may also be mounted to this lower part 913 of the at least one lighting housing 910′. In the embodiments of FIGS. 9A-9Bn the lower part 913 further comprises a plurality of aerating vents 914 extending along the periphery of the lower part 913. The plurality of aerating vents 914 is configured for enabling additional air flow to cool down the plurality of lighting housings 910, 910′.

The cooling housing 920 may be arranged in a direction opposite the plurality of lighting housings 910, 910′ in a complementary manner with the plurality of lighting housings 910, 910′. The cooling housing 920 and the plurality of lighting housings 910, 910′ may be fixed to each other using a spacing means (not shown).

The spacing means is configured for arranging the plurality of lighting housings 910, 910′ and the cooling housing 920 at a distance of each other such that a plurality of air flow channels 940, two air flow channels 940 in the embodiment of FIG. 9A, are defined. The spacing means may comprise at least one spacer and at least one fixing means, e.g. nut and bolt, screw, etc.

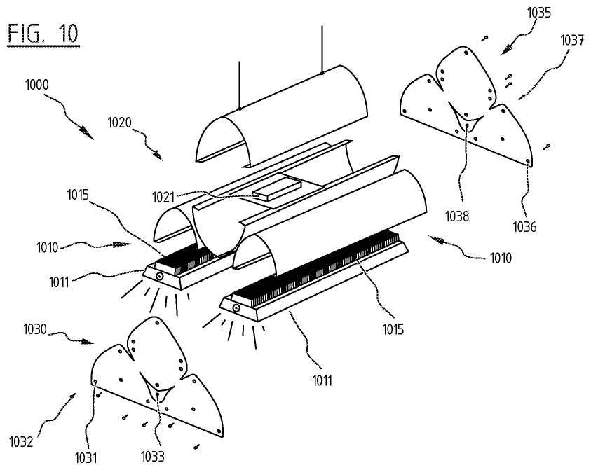

FIG. 10 illustrates an exploded perspective view of another exemplary embodiment of a lighting apparatus according to the present invention. The lighting apparatus 1000 comprises a plurality of housings 1010, 1020. The plurality of housings 1010, 1020 may comprise a plurality of lighting housings 1010 and a functional housing 1020.

Each of the plurality of lighting housings 1010 may be provided with at least one lighting unit 1011 as well as a heat sink 1015 provided to it. The functional housing 1020 may be provided with a functional electronic component, e.g. a driving means 1021. For example, the functional housing 1020 may be provided with a driving means 1021 configured for driving the plurality of lighting units 1011.

In the embodiment of FIG. 10, the plurality of housings 1010, 1020 may comprise one or more substantially V-shaped elongated profiles made by extrusion. The substantially V-shaped elongated profiles may be made in a thermally-conductive material, preferably metal, more preferably aluminum. The substantially V-shaped elongated profiles may define open profiles with an open end.

In the case of the plurality of lighting housings 1010, the open end may be provided with the at least one lighting unit 1011 to close it off. In the case of the functional housing 1020, two substantially elongated profiles, two V-shaped profiles similar to the ones used for the plurality of lighting housings 1010, may be arranged such that their respective open ends correspond, each of the two V-shaped profiles composing half of the functional housing 1020. The driving means 1021 is arranged within the functional housing 1020, mounted to a mounted board 1022 extending in the middle of the functional housing 1020, within the open end.

A first end plate 1030 and a second end plate 1035 comprise a first spacing means (not shown) and a second spacing means (not shown), respectively. A first plurality of fixation holes 1031 and a second plurality of fixation holes 1036 are provided to the first end plate 1030 and the second end plate 1035, respectively. The plurality of housings 1010, 1020 are configured to be mounted by their extremities to the first end plate 1030 and the second end plate 1035 using a first plurality of fixation means 1032 and a second plurality of fixation means 1037, respectively, cooperating with the first and second plurality of fixation holes 1031, 1036. By arranging the plurality of housings 1010, 1020 according to the placement of the first and second plurality of fixation holes 1031, 1036, the plurality of housings 1010, 1020 are spaced apart from each other such that a plurality of air flow channels is created. A first passage 1033 in the first end plate 1030 and/or a second passage 1038 in the second end plate 1035 may allow for electrical cabling to be going through extremities of the lighting apparatus 1000.

In the embodiment of FIG. 10, also the at least one lighting unit 1011 is configured to be mounted to the first end plate 1030 and the second end plate 1035, respectively, by its extremities using the first and second plurality of fixation holes 1031, 1036 and the first and second plurality of fixation means 1032, 1037. In an embodiment, inclination of the at least one lighting unit 1011 may be different between the two lighting housings 1010.

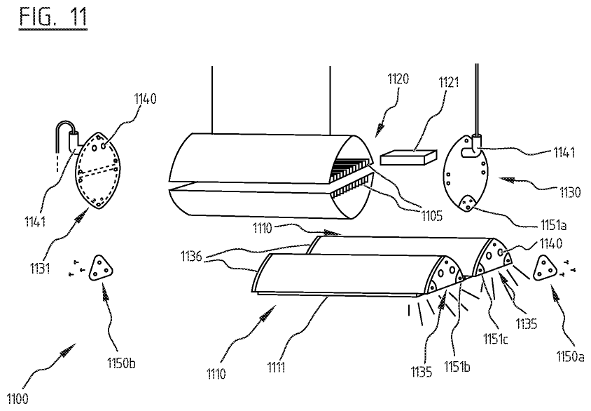

FIG. 11 illustrates an exploded perspective view of another exemplary embodiment of a lighting apparatus according to the present invention. The lighting apparatus 1100 comprises a plurality of housings 1110, 1120. The plurality of housings 1110, 1120 may comprise a plurality of lighting housings 1110 and a functional housing 1120.

Each of the plurality of lighting housings 1110 may be provided with at least one lighting unit 1111. The functional housing 1120 may be provided with a functional electronic component, e.g. a driving means 1121. For example, the functional housing 1120 may be provided with a driving means 1121 configured for driving the plurality of lighting units 1111.

In the embodiment of FIG. 11, the plurality of housings 1110, 1120 may comprise one or more substantially V-shaped elongated profiles made by extrusion. The substantially V-shaped elongated profiles may be made in a thermally-conductive material, preferably metal, more preferably aluminum. The substantially V-shaped elongated profiles may define closed profiles with a closed bottom end. Additionally, in the embodiment of FIG. 11, the closed bottom end may comprise a plurality of fins 1105 extending inwardly substantially perpendicular to the closed bottom end to act as a heat sink.

In the case of the plurality of lighting housings 1110, the closed bottom end may be provided with the at least one lighting unit 1111 in thermal contact thereof such as to dissipate the heat from the at least one lighting unit 1111 during light emission, through the plurality of fins 1105.

In the case of the functional housing 1120, two substantially elongated profiles, in FIG. 11 two V-shaped profiles similar to the ones used for the plurality of lighting housings 1110, may be arranged such that their respective closed bottom ends correspond, each of the two V-shaped profiles composing half of the functional housing 1120. Thus, two distinct and separate compartments are created by each of the two V-shaped profiles of the functional housing 1120.

The driving means 1121 is arranged within one of the two V-shaped profile of the functional housing 1120.

A first double end plate 1130 and a second double end plate 1131 are configured to close off the extremities of the functional housing 1120. For each of the plurality of lighting housings 1110, a first single end plate 1135 and a second single end plate 1136 are configured to close off the extremities of the associated lighting housing 1110.

The first and second double end plates 1130, 1131 comprise on their internal surfaces indents corresponding with the profile of the functional housing. 1120. Similarly, the first and second single end plates 1135, 1136 comprise on their internal surfaces indents corresponding with the profile of the lighting housing 1110. Additionally, in the embodiment of FIG. 11, the first and second double end plates 1130, 1131, and the first and second single end plates 1135, 1136 comprise a plurality of passages 1140 configured for cooperating with a plurality of electrical connectors 1141 in order to power electrical components of the lighting apparatus 1100.

A plurality of spacing means 1150, 1155, triangular shaped in the embodiment of FIG. 11, are configured for spacing the plurality of housings 1110, 1120 from each other such as to create a plurality of air flow channels between them. The plurality of spacing means 150, 155 is configured for cooperating with a corresponding plurality of spacing indents 1151a, 1151b, 1551c of the first and second double end plates 1130, 1131 and of the first and second single end plates 1135, 1136. More specifically, each of the first and second single end plates 1135, 1136 comprises a lower right spacing indent 1151b and a lower left spacing indent 1151c; and each of the first and second double end plates 1130, 1131 comprises a central low spacing indent 1151a. Each of the lower right spacing indent 1151b, lower left spacing indent 1151c, and central low spacing indent 1151a fits with a corner of the corresponding triangular shaped spacing means 1150 mounted to the first and second double end plates 1130, 1131 and of the first and second single end plates 1135, 1136.

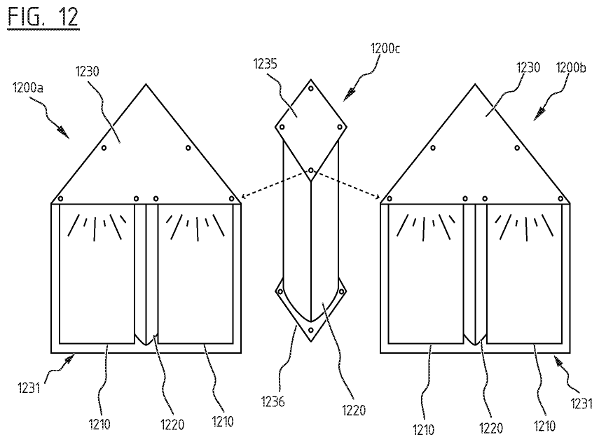

FIG. 12 illustrates an exploded perspective view of another exemplary embodiment of a lighting apparatus according to the present invention. The lighting apparatus 1200a, 1200b, 1200c comprises a plurality of housings 1210, 1220. The plurality of housings 1210, 1220 may comprise a plurality of lighting housings 1210 and a plurality of functional housings 1220. The plurality of lighting housings 1210 may be triangular shaped and the plurality of functional housings 1220 may be lozenge shaped.

In the embodiment of FIG. 12, a first and second module end plate 1230, 1231 may be used to assemble a first and a second module 1200a, 1200b comprising each two lighting housings 1210 and one functional housing 1220. The first and second module end plate 1230, 1231 are configured for spacing apart from each other the two lighting housings 1210 and the functional housing 1220 such as to create air flow channels between them.

In the embodiment of FIG. 12, a first and second joining end plate 1235, 1236 may be used at both extremities of at least one functional housing 1220, thereby forming a joining module 1200c. The first and second joining end plate 1235, 1236 are configured for being arranged between the first and the second module 1200a, 1200b and for being mounted to the first and the second module 1200a, 1200b such as to extend the lighting apparatus 1200a, 1200b, 1200c laterally. Additionally, the first and second joining end plate 1235, 1236 are configured for creating a first air flow channel between the first module 1200a and the joining module 1200c, and for creating a second air flow channel between the second module 1200a and the joining module 1200c.

The skilled person will understand that at least one of the functional housings 1220 may be replaced by a dummy housing and that more than two modules may be joined to each other in the same manner as described above using a plurality of joining modules.

Whilst the principles of the invention have been set out above in connection with specific embodiments, it is to be understood that this description is merely made by way of example and not as a limitation of the scope of protection which is determined by the appended claims.

1. A lighting apparatus comprising:
a plurality of housings comprising a first housing having a first wall and a second housing having a second wall, wherein said first wall faces said second wall;
at least one lighting unit being provided to the first housing; and
a spacing means configured for arranging said first wall at a distance of said second wall such that an air flow channel is defined between the first wall and the second wall, a minimum distance between the first wall and the second wall being at most 3 cm, preferably at most 1 cm, more preferably at most 5 mm, and being at least 0.5 mm, preferably larger than 1 mm, said air flow channel extending in an upward direction between an air entrance and an air exit,
wherein said first wall and said second wall are made of a thermally conductive material.

2. The lighting apparatus according to claim 1, wherein the second housing accommodates a driving means configured for driving the at least one lighting unit.

3. The lighting apparatus according to claim 1, wherein the first wall and the second wall are arranged to face each other over an area, A, which is larger than 300 cm², and/or
wherein the air flow channel has a length, l, and a width, w, perpendicular to the length, said width extending in a flow direction of the air flow channel, said length being longer than said width, wherein preferably said length is between 20 cm and 120 cm, and wherein preferably said width is between 5 cm and 30 cm.

4. (canceled)

5. The lighting apparatus according to claim 1, wherein the distance between the first wall and the second wall increases in a first section when looking in a downstream direction from the air entrance to the air exit, such that a Venturi effect is created.

6. The lighting apparatus of claim 5, wherein the distance between the first wall and the second wall decreases in a second section when looking in the downstream direction, said second section being upstream of the first section.

7. The lighting apparatus of claim 1, wherein a portion of the first wall and/or a portion of the second wall has a convex outer surface as seen in a cross-section along the flow direction, and
wherein the portion of the first wall preferably has a convex outer surface arranged symmetrically with respect to the portion of the second wall having a convex outer surface as seen in a section along the flow direction.

8. (canceled)

9. The lighting apparatus of claim 1, wherein each of the first housing and the second housing comprises an elongate profile with a length direction extending preferably perpendicular to the flow direction in the air flow channel in a plane substantially parallel to the first wall and/or the second wall, and
wherein the first wall and the second wall are preferably an elongate first side wall of the first housing and an elongate second side wall of the second housing, respectively.

10. (canceled)

11. The lighting apparatus of claim 1, wherein each of the first housing and the second housing comprises an extruded profile, and wherein each of the first housing and the second housing preferably comprises at least one extruded profile having a similar shape.

12. (canceled)

13. The lighting apparatus of claim 1, wherein the first housing has a substantially triangular cross-section and the second housings has a substantially lozenge cross-section, and the second housing is oriented such as to have a corner pointing upward and the first housing is oriented such as to have a corner pointing upward.

14. The lighting apparatus of claim 1, wherein the spacing means comprises an end plate, wherein the end plate is configured for being fixed to an end of the first housing and an end of the second housing, and, optionally, wherein the end plate comprises at least one passage configured for receiving an electrical power cabling.

15. The lighting apparatus of claim 9, wherein the spacing means comprises an end plate, wherein the end plate is configured for being fixed to an end of the first housing and an end of the second housing, and wherein the end plate closes an end of the first housing and an end of the second housing.

16. (canceled)

17. The lighting apparatus of claim 1, further comprising:
a third housing comprising a third wall;
the second housing comprising another second wall, said another second wall facing the third wall; and
at least one electronic component, preferably another lighting unit, being provided to the third housing,
wherein the spacing means is further configured for arranging said another second wall at a distance of the third wall such that another air flow channel is defined between the another second wall and the third wall, a minimum distance between the another second wall and the third wall being at most 3 cm, preferably at most 1 cm, more preferably at most 5 mm, and being larger than 0.5 mm, preferably larger than 1 mm, said another air flow channel extending in an upward direction between an air entrance and an air exit, and
wherein said another second and said third wall are made of a thermally conductive material.

18. The lighting apparatus of claim 17, wherein each of the first housing, the second housing, and the third housing comprises an elongate profile with a length direction extending preferably perpendicular to the flow direction in the air flow channel in a plane substantially parallel to the first wall, the second wall, the another second wall, and/or the third wall, and
wherein the first wall, the second wall, the another second wall, and the third wall are preferably an elongate first side wall of the first housing, a first elongate second side wall and a second elongate second side wall of the second housing, and an elongate first side wall of the third housing, respectively.

19. (canceled)

20. The lighting apparatus of claim 18, wherein the first housing and the third housing are arranged along a first arrangement level, and the second housing is arranged along a second arrangement level above the first arrangement level as seen in a plane perpendicular to the length direction.

21. The lighting apparatus of claim 20, wherein the second housing accommodates a driving means configured for driving the at least one lighting unit, and wherein the at least one lighting unit comprises a first lighting unit provided to the first housing and a second lighting unit provided to the third housing.

22. The lighting apparatus of claim 1, wherein the plurality of housings comprises at least five housings arranged to define at least four air flow channels, or even seven housings arranged to define at least six air flow channels.

23. (canceled)

24. The lighting apparatus of claim 1, wherein the at least one lighting unit is an LED lighting unit, and
optionally, wherein the first housing comprises a transparent or translucent lower cover, and wherein the LED lighting unit is arranged within the first housing to face the transparent or translucent lower cover.

25. (canceled)

26. The lighting apparatus of claim 1, wherein the at least one lighting unit is provided with a thermal dissipation means within the first housing.

27. A modular lighting apparatus comprising at least a first substantially V-shaped elongate profile, a second substantially V-shaped elongate profile, a third substantially V-shaped elongate profile, and a fourth substantially V-shaped elongate profile,
wherein at least one of the first substantially V-shaped elongate profile and the second substantially V-shaped elongate profiles houses a light source, and, optionally, a transparent or translucent cover closes the V-shaped profile,
wherein the third substantially V-shaped elongate profile and the fourth substantially V-shaped elongate profile are combined with their open sides facing each other so as to form a housing for one or more other components, such as a driving means of the light source,
wherein, in a mounted state, the first substantially V-shaped elongate profile and the second substantially V-shaped elongate profile are arranged parallel to each other with their open side oriented downward, and wherein the combination of the third substantially V-shaped elongate profile and the fourth substantially V-shaped elongate profile is arranged in between the first substantially V-shaped elongate profile and the second substantially V-shaped elongate profile with the open side of the third substantially V-shaped elongate profile oriented upward, such that a first wall of the third substantially V-shaped elongate profile faces a second wall of the first substantially V-shaped elongate profile and such that a second wall of the third substantially V-shaped elongate profile faces a first wall of the second substantially V-shaped elongate profile, and
wherein, preferably, the first substantially V-shaped elongate profile, the second substantially V-shaped elongate profile, the third substantially V-shaped elongate profile, and the fourth substantially V-shaped elongate profile have similar shapes.

28. (canceled)

29. A suspended modular lighting comprising at least two, preferably at least three, substantially V-shaped elongate profiles arranged parallel to each other between two end plates such as to define at least one air flow channel for cooling the V-shaped elongate profiles, wherein each substantially V-shaped elongate profile accommodates a light source, and wherein a first profile of said at least two elongate profiles is rotated with respect to a second profile of said at least two elongate profiles such that an orientation of a light beam emitted by the light source accommodated in the first profile is different from an orientation of a light beam emitted by the light source accommodated in the second profile.
